(19) United States
(12) Patent Application Publication
(10) Pub. No.: US 2005/0193334 A1
(43) Pub. Date: Sep. 1, 2005

(54) Layout system, layout apparatus, layout program, template selection program, storage medium having stored therein layout program, and storage medium having stored therein template selection program, as well as layout method

(75) Inventors: Hirotaka Ohashi, Suwa-shi (JP); Toshio Tanaka, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/067,668

(22) Filed: Feb. 28, 2005

(30) Foreign Application Priority Data
Feb. 26, 2004 (JP) 2004-051701
Oct. 14, 2004 (JP) 2004-299940

(51) Int. Cl. G06F 17/00; G06F 17/24

(52) U.S. Cl. 715/517; 715/513; 715/530

(57) ABSTRACT

A layout system and method that is suitable for realizing an attractive layout and improving usability of an existing layout includes, when it is judged that a layout consistent with a logical structure of a structured document is not present in a template registration DB, a layout apparatus selects a layout template, which has the same number of information storage frames as the number of the layout elements included in the structured document, from the template registration DB. Then, the layout apparatus changes a logical structure of the selected layout template on the basis of the logical structure of the structured document and stores the layout elements, which are included in the structured document, in information storage frames in accordance with the changed layout template to perform layout.

### BACKGROUND

The present exemplary embodiments relate to a system, an apparatus, a program, and a storage medium, as well as a method for laying out a structured document or an XML (extensible Markup Language) or the like. In particular, the exemplary embodiments relate to a layout system, a layout apparatus, a layout program, a template selection program, a storage medium having stored therein the layout program, and a storage medium having stored therein the template selection program, as well as a layout method that is suitable for realizing an attractive layout and improving usability of an existing layout.

In the related art, as a technique for laying out a structured document of the XML or the like, for example, there is a document creation apparatus disclosed in JP-A-7-93329 and a document processing apparatus disclosed in JP-A-7-219945.

As described in JP-A-7-93329, when a text is inputted, the document creation apparatus reads out a designated example sentence from an external storage, subjects the read-out example sentence to logical analysis to obtain a logical structure and obtain style information from this logical structure, and subjects the inputted text to the logical analysis to obtain a logical structure. Then, when the logical structures of the example sentence and the text are identical with each other, the document creation apparatus adjusts the text to a style of the example sentence and shapes the text on the basis of the style information of the example sentence and the logical structure of the text. Consequently, the text is automatically adjusted to a style identical with the existing example text.

As described in JP-A-7-219945, when an instruction for document edition processing is inputted, the document processing apparatus reads out an electronic document from a storage unit in accordance with the inputted instruction and changes a certain information storage frame to an in-frame frame of another information storage frame or changes an in-frame frame of a certain information storage frame to an independent information storage frame to thereby create an electronic document. Then, the document processing apparatus stores the created electronic document in the storage unit and outputs a processing result to a display unit.

### SUMMARY

In layout of a structured document, since it is likely that readability and attractiveness of the document are spoiled if the layout is performed mechanically, as described in JP-A-7-93329, a method of storing plural existing structured document samples in advance and laying out a structured document using a logical structure of a structured document sample has been proposed. With this method, since an existing layout can be used, it is possible to realize an attractive layout.

However, the exemplary embodiment described in JP-A-7-93329 has a problem in that, when the logical structure of the text and the logical structure of the example sentence are not identical with each other, since the text cannot be laid out using the logical structure of the example sentence, usability of the example sentence is low. Thus, in order to cope with texts of all logical structures, an enormous number of example sentences must be prepared.

In addition, JP-A-7-93329 teaches that when the logical structure of the text and the logical structure of the example sentence are not identical with each other, the text is laid out according to style information held by the apparatus. According to JP-A-7-219945, layout is performed by changing a certain storage frame to an in-frame frame of another information storage frame or changing an in-frame frame of a certain information storage frame to an independent information storage frame. However, according to JP-A-7-93329 and JP-A-7-219945, layout is simply performed mechanically, and there is a problem in that it is difficult to realize an attractive layout.

Thus, the exemplary embodiments have been devised in view of the unsolved problems of the related art, and the exemplary embodiments provide a layout system, a layout apparatus, a layout program, a template selection program, a storage medium having stored therein the layout program, and a storage medium having stored therein the template selection program, as well as a layout method that are suitable for realizing an attractive layout and improving usability of an existing layout.

### First Exemplary Embodiment

A layout system of a first exemplary embodiment is a layout system that lays out structured data in which plural layout elements are logically structured, including: a template selecting device that selects a layout template defining a layout of plural information storage frames; a template structure changing device that changes a logical structure of the layout template selected by the template selecting device on the basis of a logical structure of the structured data; and a layout device that stores the layout elements, which are included in the structured data, in the information storage frames to perform layout in accordance with the layout template changed by the template structure changing device, the template selecting device selecting a layout template which has the same number of information storage frames as the number of the layout elements included in the structured data.

With such a constitution, a layout template, which has the same number of information storage frames as the number of the layout elements included in the structured data, is selected by the template selecting device. Then, the logical structure of the selected layout template is changed by the template structure changing device on the basis of the logical structure of the structured data, and the layout elements included in the structured data are stored in the information storage frames in accordance with the layout template with the changed logical structure, whereby layout is performed.

Consequently, since the structured data is laid out in accordance with the layout template, there is an advantage that it is possible to use an existing layout and realize a relatively attractive layout compared with that of the related art. In addition, since the logical structure of the layout template close to the logical structure of the structured data is changed to be used, there is also an advantage that it is possible to improve usability of the existing layout compared with that of the related art.

Here, “logically structuring” refers to defining a combination relation of plural layout elements. For example, a state corresponding to this is a state in which plural layout elements such as a text, an image, and a figure exist and the respective layout elements have a combination relation (parent-child relation) like a “paragraph” present in the “text”. In other words, the layout system only has to be able to specify what kinds of layout elements constitute the structured data and what kind of combination relation the layout elements have.

The same holds true for a layout system of a second exemplary embodiment, layout apparatuses of an eighth and a ninth exemplary embodiment, layout programs of a fifteenth and a sixteenth exemplary embodiment, template selection programs of a twenty-second and a twenty-third exemplary embodiment, storage media having stored therein layout programs of a twenty-fourth and a twenty-fifth exemplary embodiment, storage media having stored therein template selection programs of a twenty-sixth and a twenty-seventh exemplary embodiment, and layout methods of a twenty-eighth, a twenty-ninth, a thirty-fifth, and a thirty-sixth layout methods.

The logical structure of the structured data refers to a structure in which plural layout elements are logically structured, and the logical structure of the layout template refers to a structure in which plural information storage frames are logically structured. The same holds true for the layout system of the second exemplary embodiment, the layout apparatuses of the eighth and the ninth exemplary embodiment, the layout programs of the fifteenth and the sixteenth exemplary embodiment, the template selection programs of the twenty-second and the twenty-third exemplary embodiment, the storage media having stored therein layout programs of the twenty-fourth and the twenty-fifth exemplary embodiment, the storage media having stored therein template selection programs of the twenty-sixth and the twenty-seventh exemplary embodiment, and the layout methods of the twenty-eighth, the twenty-ninth, the thirty-fifth, and the thirty-sixth layout methods.

The structured data may be any data structure as long as plural layout elements are logically structured in the data structure. For example, the structured data may be constituted integrally with the layout elements or may be constituted separately from the layout elements. In the latter case, for example, it is possible to realize the structured data by adopting a data structure including reference information for referring to the layout elements. In addition, the structured data may be constituted integrally with a part of the plural layout elements or may be constituted separately from the remaining part of the layout elements. The same holds true for a layout system of the second exemplary embodiment, layout apparatuses of the eighth and the ninth exemplary embodiment, layout programs of the fifteenth and the sixteenth exemplary embodiment, template selection programs of the twenty-second and the twenty-third exemplary embodiment, storage media having stored therein layout programs of the twenty-fourth and the twenty-fifth exemplary embodiment, storage media having stored therein template selection programs of the twenty-sixth and the twenty-seventh exemplary embodiment, and layout methods of the twenty-eighth, the twenty-ninth, the thirty-fifth, and the thirty-sixth layout methods.

The structure data may have any data structure as long as the data structure can specify a logical structure of the structured data. For example, the structured data may have a data structure that includes information on a logical structure of the layout elements to thereby explicitly specify the logical structure or may have a data structure that indirectly specifies a logical structure of the structured data according to an arrangement or the like of the layout elements in the structured data. The same holds true for a layout system of the second exemplary embodiment, layout apparatuses of the eighth and the ninth exemplary embodiment, layout programs of the fifteenth and the sixteenth exemplary embodiment, template selection programs of the twenty-second and the twenty-third exemplary embodiment, storage media having stored therein layout programs of the twenty-fourth and the twenty-fifth exemplary embodiment, storage media having stored therein template selection programs of the twenty-sixth and the twenty-seventh exemplary embodiment, and layout methods of the twenty-eighth, the twenty-ninth, the thirty-fifth, and the thirty-sixth layout methods.

The layout elements include character information, image information, and other elements that are capable of constituting a layout. Taking a structured document for instance, elements such as a heading, a sub-heading, a lead (preamble), a text, a paragraph, an image, an illustration, a table, and a caption corresponding to the layout elements. The same holds true for the layout system of the second exemplary embodiment, the layout apparatuses of the eighth and the ninth exemplary embodiment, the layout programs of the fifteenth and the sixteenth exemplary embodiment, the template selection programs of the twenty-second and the twenty-third exemplary embodiment, the storage media having stored therein layout programs of the twenty-fourth and the twenty-fifth exemplary embodiment, the storage media having stored therein template selection programs of the twenty-sixth and the twenty-seventh exemplary embodiment, and the layout methods of the twenty-eighth, the twenty-ninth, the thirty-fifth, and the thirty-sixth layout methods.

The information storage frame may have any structure as long as the structure is adapted to store the layout elements. Taking a layout template applied to the structured document for instance, information storage frames such as a heading storage frame, a sub-heading storage frame, a lead (preamble) storage frame, a text storage frame, a paragraph storage frame, an image storage frame, an illustration storage frame, a table storage frame, and a caption storage frame correspond to the information storage frame. In addition, the information storage frame is a frame for storing the layout elements in a predetermined layout area and includes a virtual (logical) frame. This frame is not always necessary in layout unless the frame is drawn in a form of a frame line. The virtual frame may be recognized or may not be recognized visually. The same holds true for the layout system of the second exemplary embodiment, the layout apparatuses of the eighth and the ninth exemplary embodiment, the layout programs of the fifteenth and the sixteenth exemplary embodiment, the template selection programs of the twenty-second and the twenty-third exemplary embodiment, the storage media having stored therein layout programs of the twenty-fourth and the twenty-fifth exemplary embodiment, the storage media having stored therein template selection programs of the twenty-sixth and the twenty-seventh exemplary embodiment, and the layout methods of the twenty-eighth, the twenty-ninth, the thirty-fifth, and the thirty-sixth layout methods.

The layout refers to arrangement of the information storage frames. In addition, the layout includes determination of arrangement positions or sizes of the information storage frames or change of attributes of the information storage frames. As the attributes of the information storage frames, for example, in the case of an information storage frame for storing character information, attributes such as a type of a font, a character size, a color of a character, a color of a background, character alignment, and the like correspond to the attributes. In the case of an information storage frame for storing image information, attributes such as a quality, a size, an aspect ration, trimming, and the like of the image information correspond to the attributes. The same holds true for the layout system of the second exemplary embodiment, the layout apparatuses of the eighth and the ninth exemplary embodiment, the layout programs of the fifteenth and the sixteenth exemplary embodiment, the template selection programs of the twenty-second and the twenty-third exemplary embodiment, the storage media having stored therein layout programs of the twenty-fourth and the twenty-fifth exemplary embodiment, the storage media having stored therein template selection programs of the twenty-sixth and the twenty-seventh exemplary embodiment, and the layout methods of the twenty-eighth, the twenty-ninth, the thirty-fifth, and the thirty-sixth layout methods.

In addition, for example, when layout is performed for the purpose of displaying a document on a screen, the layout refers to a layout for the display. When layout is performed for the purpose of printing a document on a paper surface, the layout refers to a layout for the printing. The same holds true for the layout system of the second exemplary embodiment, the layout apparatuses of the eighth and the ninth exemplary embodiment, the layout programs of the fifteenth and the sixteenth exemplary embodiment, the template selection programs of the twenty-second and the twenty-third exemplary embodiment, the storage media having stored therein layout programs of the twenty-fourth and the twenty-fifth exemplary embodiment, the storage media having stored therein template selection programs of the twenty-sixth and the twenty-seventh exemplary embodiment, and the layout methods of the twenty-eighth, the twenty-ninth, the thirty-fifth, and the thirty-sixth layout methods.

This system may be realized as a single apparatus, terminal, or other apparatus or may be realized as a network system connected to plural apparatuses, terminal, or other apparatuses so as to be capable of communicating with one another. In the latter case, respective components may belong to any one of the plural apparatuses or the like as long as the components are connected to as to be capable of communicating with one another. The same holds true for the layout system of the second exemplary embodiment.

### Second Exemplary Embodiment

A layout system of a second exemplary embodiment is a layout system that lays out structured data in which plural layout elements are logically structured, including: a template storing device that stores plural layout templates defining layouts in which plural information storage frames are arranged in a predetermined layout area; a template selecting device that selects the layout template from the template storing device; a template structure changing device that changes a logical structure of the layout template selected by the template selecting device on the basis of a logical structure of the structured data; and layout device that stores the layout elements, which are included in the structured data, in the information storage frames to perform layout in accordance with the layout template changed by the template structure changing device, when it is judged that a layout template consistent with the logical structure of the structured data is not present in the template storing device, the template selecting device selects a layout template which has the same number of information storage frames as the number of the layout elements included in the structured data.

With such a constitution, when it is judged that a layout template consistent with the logical structure of the structured data is not present in the template storing device, a layout template, which has the same number of information storage frames as the number of the layout elements included in the structured data, is selected by the template selecting device. Then, the logical structure of the selected layout template is changed by the template structure changing device on the basis of the logical structure of the structured data, and the layout elements included in the structured data are stored in the information storage frames in accordance with the layout template with the changed logical structure, whereby layout is performed.

Consequently, since the structured data is laid out in accordance with the layout template, there is an advantage that it is possible to use an existing layout and realize a relatively attractive layout compared with that of the related art. In addition, since the logical structure of the layout template close to the logical structure of the structured data is changed to be used, there is also an advantage that it is possible to improve usability of the existing layout compared with that of the related art.

Here, the template storing device stores the layout templates with all device and in all periods. The template storing device may be a template storing device that stores the templates in advance or may be adapted to store the layout templates by an input or the like from the outside at the time of operation of this system. The same holds true for a case in which the layout elements are stored in the layout element storing device. In addition, the same holds true for the layout apparatus of the ninth exemplary embodiment and the layout program of the sixteenth exemplary embodiment.

### Third Exemplary Embodiment

A layout system of a third exemplary embodiment, in the layout system of the second exemplary embodiment, includes at least one of attributes of the layout elements and attributes of information storage frames, in which the layout elements should be stored, being set for the layout elements, at least one of attributes of layout elements, which should be stored in the information storage frames, and attributes of the information storage frames being set in the information storage frames, and for each attribute of the layout elements included in the structured data, the template selecting device selects a layout template, which has the same number of information storage frames of the attribute as the number of layout elements of the attribute included in the structured data.

With such a constitution, for each attribute of the layout elements included in the structured data, a layout template, which has the same number of information storage frames of the attribute as the number of layout elements of the attribute included in the structured data, is selected by the template selecting device.

Consequently, a logical structure of a layout template closer to the logical structure of the structured data is changed to be used. Thus, there is an advantage that it is possible to realize a more attractive layout.

Here, as a form for setting attributes for layout elements and information storage frames, at least the following three forms are possible. A first form is a form for setting attributes of layout elements for the layout elements and setting attributes of layout elements, which should be stored in information storage frames, for the information storage frames. A second form is a form for setting attributes of information storage frames, in which layout elements should be stored, for the layout elements and setting attributes of information storage frames for the information storage frames. A third form is a form for setting attributes of both layout elements and information storage frames, in which the layout elements should be stored, for the layout elements and setting attributes of both layout elements, which should be stored in information storage frames, and the information storage frames in the information storage frames. The same holds true for a layout apparatus of a tenth exemplary embodiment, a layout program of a seventeenth exemplary embodiment, and a layout method of a thirtieth exemplary embodiment.

### Fourth Exemplary Embodiment

A layout system of a fourth exemplary embodiment, in the layout system of the second or the third exemplary embodiment, include that when it is judged that a layout template, which has the same number of information storage frames as the number of the layout elements included in the structured data, is not present in the template storing device, the template selecting device selects a layout template which has the number of the information storage frames closest to the number of the layout elements included in the structured data.

With such a constitution, when it is judged that a layout template, which has the same number of information storage frames as the number of the layout elements included in the structured data, is not present in the template storing device, a layout template, which has the number of the information storage frames closest to the number of the layout elements included in the structured data, is selected by the template selecting device.

Consequently, even if a layout template, which has the same number of information storage frames as the number of the layout elements included in the structured data, is not present, since a logical structure of a layout template close to the logical structure of the structured data is changed to be used, there is an advantage that it is possible to further improve usability of an existing layout.

### Fifth Exemplary Embodiment

A layout system of the fifth exemplary embodiment, in the layout system of the fourth exemplary embodiment, includes the template structure changing device adding or deleting an information storage frame to or from a layout, which is defined by the layout template selected by the template selecting device, such that the number of the layout elements included in the structured data and the number of the information storage frames are identical with each other and, then, changes a logical structure of the layout template.

With such a constitution, an information storage frame is added to or deleted from a layout, which is defined by the layout template selected by the template selecting device, such that the number of the layout elements included in the structured data and the number of the information storage frames are identical with each other and, then, a logical structure of the layout template is changed by the template structure changing device.

Consequently, since an information storage frame is added or deleted such that the layout template is consistent with the logical structure of the structured data and, then, a logical structure of the layout template is changed, there is an advantage that it is possible to realize a more attractive layout.

### Sixth Exemplary Embodiment

A layout system of a sixth exemplary embodiment includes, in the layout system of any one of the second to the fifth exemplary embodiments, an information storage frame adjusting device that adjusts arrangement positions and sizes of the information storage frames in the layout, which is defined by the layout template changed by the template structure changing device, on the basis of predetermined adjustment rules.

With such a constitution, arrangement positions and sizes of the information storage frames in the layout, which is defined by the layout template changed by the template structure changing device, are adjusted by the information storage frame adjusting device on the basis of predetermined adjustment rules.

Consequently, since arrangement positions and sizes of the information storage frames are adjusted on the basis of the predetermined adjustment rules, there is an advantage that it is possible to realize a more attractive layout.

### Seventh Exemplary Embodiment

A layout system of a seventh exemplary embodiment, in the layout system of the sixth exemplary embodiment, includes the predetermined adjustment rules defined on the basis of design knowledge.

With such a constitution, arrangement positions and sizes of the information storage frames are adjusted in a layout, which is defined by the layout template with the changed logical structure, on the basis of the adjustment rules defined on the basis of the design knowledge by the information storage frame adjusting device.

Consequently, since arrangement positions and sizes of the information storage frames are adjusted on the basis of the design knowledge, there is an advantage that it is possible to realize a more attractive layout.

Here, the design knowledge refers to know-how, a theory, and other knowledge concerning design. The same holds true for a layout apparatus of a fourteenth exemplary embodiment, a layout program of a twenty-first exemplary embodiment, and a layout method of a thirty-fourth exemplary embodiment.

### Eighth Exemplary Embodiment

On the other hand, a layout apparatus of an eighth exemplary embodiment is a layout apparatus that lays out structured data in which plural layout elements are logically structured, including: a template selecting device that selects a layout template defining a layout of plural information storage frames; a template structure changing device that changes a logical structure of the layout template selected by the template selecting device on the basis of a logical structure of the structured data; and a layout device that stores the layout elements, which are included in the structured data, in the information storage frames to perform layout in accordance with the layout template changed by the template structure changing device, the template selecting device selects a layout template which has the same number of information storage frames as the number of the layout elements included in the structured data.

With such a constitution, an action and an advantage equivalent to those in the layout system of the first exemplary embodiment are obtained.

### Ninth Exemplary Embodiment

A layout apparatus of a ninth exemplary embodiment is a layout apparatus that lays out structured data in which plural layout elements are logically structured, including: a template storing device that stores plural layout templates defining layouts in which plural information storage frames are arranged in a predetermined layout area; a template selecting device that selects the layout template from the template storing device; a template structure changing device that changes a logical structure of the layout template selected by the template selecting device on the basis of a logical structure of the structured data; and a layout device that stores the layout elements, which are included in the structured data, in the information storage frames to perform layout in accordance with the layout template changed by the template structure changing device, when it is judged that a layout template consistent with the logical structure of the structured data is not present in the template storing device, the template selecting device selects a layout template which has the same number of information storage frames as the layout elements included in the structured data.

With such a constitution, an action and an advantage equivalent to those in the layout system of the second exemplary embodiment are obtained.

### Tenth Exemplary Embodiment

A layout apparatus of a tenth exemplary embodiment, in the layout apparatus of the ninth exemplary embodiment, includes at least one of attributes of the layout elements and attributes of information storage frames, in which the layout elements should be stored, being set for the layout elements, at least one of attributes of layout elements, which should be stored in the information storage frames, and attributes of the information storage frames being set in the information storage frames, and for each attribute of the layout elements included in the structured data, the template selecting device selects a layout template, which has the number of information storage frames of the attribute identical with the number of layout elements of the attribute included in the structured data.

With such a constitution, an action and an advantage equivalent to those in the layout system of the third exemplary embodiment are obtained.

### Eleventh Exemplary Embodiment

A layout apparatus of an eleventh exemplary embodiment, in the layout apparatus of any one of the ninth and the tenth exemplary embodiments, includes when it is judged that a layout template, which has the same number of information storage frames as the layout elements included in the structured data, is not present in the template storing device, the template selecting device selects a layout template which has the closest number of the information storage frames as the layout elements included in the structured data.

With such a constitution, an action and an advantage equivalent to those in the layout system of the fourth exemplary embodiment are obtained.

### Twelfth Exemplary Embodiment

A layout apparatus of a twelfth exemplary embodiment in the layout apparatus of the eleventh exemplary embodiment, includes the template structure changing device adding or deleting an information storage frame to or from a layout, which is defined by the layout template selected by the template selecting device, such that the number of the layout elements included in the structured data and the number of the information storage frames are identical with each other and, then, change a logical structure of the layout template.

With such a constitution, an action and an advantage equivalent to those in the layout system of the fifth exemplary embodiment are obtained.

### Thirteenth Exemplary Embodiment

A layout apparatus of a thirteenth exemplary embodiment further includes, in the layout apparatus of any one of the ninth to the twelfth exemplary embodiments, an information storage frame adjusting device that adjusts arrangement positions and sizes of the information storage frames in the layout, which is defined by the layout template changed by the template structure changing device, on the basis of predetermined adjustment rules.

With such a constitution, an action and an advantage equivalent to those in the layout system of the sixth exemplary embodiment are obtained.

### Fourteenth Exemplary Embodiment

A layout apparatus of a fourteenth exemplary embodiment includes, in the layout apparatus of the thirteenth exemplary embodiment, that the predetermined adjustment rules are defined on the basis of design knowledge.

With such a constitution, an action and an advantage equivalent to those in the layout system of the seventh exemplary embodiment are obtained.

### Fifteenth Exemplary Embodiment

On the other hand, a layout program of a fifteenth exemplary embodiment is a layout program for laying out structured data in which plural layout elements are logically structured, including a program to cause a computer to execute processing that includes: selecting a layout template defining a layout of plural information storage frames; changing a logical structure of the layout template selected on the basis of a logical structure of the structured data; and storing the layout elements, which are included in the structured data, in the information storage frames to perform layout in accordance with the changed layout template. A layout template, which has the same number of information storage frames as the layout elements included in the structured data, is selected.

With such a constitution, when the program is read by the computer, and the computer executes the processing in accordance with the read program, an action and an advantage equivalent to those in the layout system of the first exemplary embodiment are obtained.

### Sixteenth Exemplary Embodiment

A layout program of a sixteenth exemplary embodiment is a layout program for laying out structured data in which plural layout elements are logically structured, including a program to cause a computer, which is capable of using a template storing device that stores plural layout templates defining a layout in which plural information storage frames are arranged in a predetermined layout area, to execute processing that includes: selecting the layout template from the template storing device; changing a logical structure of the layout template selected on the basis of a logical structure of the structured data; and storing the layout elements, which are included in the structured data, in the information storage frames to perform layout in accordance with the layout template changed in the template structure changing step. When it is judged that a layout template consistent with the logical structure of the structured data is not present in the template storing device, a layout template, which has the same number of information storage frames as the layout elements included in the structured data, is selected.

With such a constitution, when the program is read by the computer, and the computer executes the processing in accordance with the read program, an action and an advantage equivalent to those in the layout system of the second exemplary embodiment are obtained.

### Seventeenth Exemplary Embodiment

A layout program of a seventeenth exemplary embodiment includes, in the layout program of the sixteenth exemplary embodiment, at least one of attributes of the layout elements and attributes of information storage frames, in which the layout elements should be stored, being set for the layout elements, at least one of attributes of layout elements, which should be stored in the information storage frames, and attributes of the information storage frames being set in the information storage frames, and for each attribute of the layout elements included in the structured data, a layout template, which has the same number of information storage frames as the layout elements of the attribute included in the structured data, is selected.

With such a constitution, when the program is read by the computer, and the computer executes the processing in accordance with the read program, an action and an advantage equivalent to those in the layout system of the third exemplary embodiment are obtained.

### Eighteenth Exemplary Embodiment

A layout program of an eighteenth exemplary embodiment including, in the layout program of the sixteenth or the seventeenth exemplary embodiment, that when it is judged that a layout template, which has the same number of information storage frames as the layout elements included in the structured data, is not present in the template storing device, a layout template, which has the closest number of the information storage frames to the layout elements included in the structured data, is selected.

With such a constitution, when the program is read by the computer, and the computer executes the processing in accordance with the read program, an action and an advantage equivalent to those in the layout system of the fourth exemplary embodiment are obtained.

### Nineteenth Exemplary Embodiment

A layout program of a nineteenth exemplary embodiment includes, in the layout program of the eighteenth exemplary embodiment, an information storage frame added to or deleted from a layout, which is defined by the layout template selected by the template selecting device, such that the number of the layout elements included in the structured data and the number of the information storage frames are identical with each other and, then, a logical structure of the layout template is changed.

With such a constitution, when the program is read by the computer, and the computer executes the processing in accordance with the read program, an action and an effect equivalent to those in the layout system of the fifth exemplary embodiment are obtained.

### Twentieth Exemplary Embodiment

A layout program of the twentieth exemplary embodiment further includes, in the layout program of any one of the sixteenth to the nineteenth exemplary embodiments, a program to cause the computer to execute processing including adjusting arrangement positions and sizes of the information storage frames in the layout, which is defined by the changed layout template, on the basis of predetermined adjustment rules.

With such a constitution, when the program is read by the computer, and the computer executes the processing in accordance with the read program, an action and an advantage equivalent to those in the layout system of the sixth exemplary embodiment are obtained.

### Twenty-First Exemplary Embodiment

A layout program of a twenty-first exemplary embodiment including, in the layout program of the twentieth exemplary embodiment, that the predetermined adjustment rules are defined on the basis of design knowledge.

With such a constitution, when the program is read by the computer, and the computer executes the processing in accordance with the read program, an action and an advantage equivalent to those in the layout system of the seventh exemplary embodiment are obtained.

### Twenty-Second Exemplary Embodiment

On the other hand, a template selection program of a twenty-second exemplary embodiment is a template selection program to select a layout template that is used for laying out structured data in which plural layout elements are logically structured, including a program to cause a computer to execute processing that includes: selecting a layout template defining a layout of plural information storage frames; changing a logical structure of the layout template selected on the basis of a logical structure of the structured data, a layout template, which has the same number of information storage frames as the layout elements included in the structured data, is selected.

With such a constitution, when the program is read by the computer, and the computer executes the processing in accordance with the read program, a layout template, which has the same number of information storage frames as the layout elements included in the structured data, is selected. Then, a logical structure of the selected layout template is changed on the basis of the logical structure of the structured data.

Consequently, an advantage equivalent to that in the layout system of the first exemplary embodiment is obtained.

### Twenty-Third Exemplary Embodiment

A template selection program of a twenty-third exemplary embodiment is a template selection program to select a layout template that is used for laying out structured data in which plural layout elements are logically structured, including a program for causing a computer, which is capable of using template storing device that stores plural layout templates defining a layout in which plural information storage frames are arranged in a predetermined layout area, to execute processing that includes: selecting the layout template from the template storing device; and changing a logical structure of the layout template selected on the basis of a logical structure of the structured data, when it is judged that a layout template consistent with the logical structure of the structured data is not present in the template storing device, a layout template, which has the same number of information storage frames as the layout elements included in the structured data, is selected.

With such a constitution, when the program is read by the computer and the computer executes the processing in accordance with the read program, and when it is judged that a layout template consistent with the logical structure of the structured data is not present in the template storing device, a layout template, which has the same number of information storage frames as the layout elements included in the structured data, is selected from the template storing device. Then, a logical structure of the selected layout template is changed on the basis of the logical structure of the structured data.

Consequently, an advantage equivalent to that in the layout system of the second exemplary embodiment is obtained.

### Twenty-Fourth Exemplary Embodiment

On the other hand, a storage medium having stored therein a layout program of a twenty-fourth exemplary embodiment is a computer readable storage medium having stored therein a layout program for laying out structured data in which plural layout elements are logically structured, storing a program to cause a computer to execute processing, the program including: a program for selecting a layout template defining a layout of plural information storage frames; a program for changing a logical structure of the layout template selected on the basis of a logical structure of the structured data; and a program for storing the layout elements, which are included in the structured data, in the information storage frames to perform layout in accordance with the changed layout template, a layout template, which has the same number of information storage frames as the layout elements included in the structured data, being selected.

With such a constitution, when the program stored in the storage medium is read by the computer, and the computer executes the processing in accordance with the read program, an action and an advantage equivalent to those in the layout program of the fifteenth exemplary embodiment are obtained.

### Twenty-Fifth Exemplary Embodiment

A storage medium having stored therein a layout program of a twenty-fifth exemplary embodiment is a computer readable storage medium having stored therein a layout program for laying out structured data in which plural layout elements are logically structured, storing a program to cause a computer, which is capable of using a template storing device that stores plural layout templates defining a layout in which plural information storage frames are arranged in a predetermined layout area, to execute processing, the program including: a program for selecting the layout template from the template storing device; a program for changing a logical structure of the layout template selected on the basis of a logical structure of the structured data; and a program for storing the layout elements, which are included in the structured data, in the information storage frames to perform layout in accordance with the changed layout template, when it is judged that a layout template consistent with the logical structure of the structured data is not present in the template storing device, a layout template, which has the same number of information storage frames as the layout elements included in the structured data, being selected.

With such a constitution, when the program stored in the storage medium is read by the computer, and the computer executes the processing in accordance with the read program, an action and an advantage equivalent to those in the layout program of the sixteenth exemplary embodiment are obtained.

### Twenty-Sixth Exemplary Embodiment

On the other hand, in order to attain the object, a storage medium having stored therein a template selection program of a twenty-sixth exemplary embodiment is a computer readable storage medium having stored therein a template selection program to select a layout template that is used for laying out structured data in which plural layout elements are logically structured, storing a program to cause a computer to execute processing, the program including: a program for selecting a layout template defining a layout of plural information storage frames; and a program for changing a logical structure of the layout template selected in the template selecting step on the basis of a logical structure of the structured data, a layout template, which has the same number of information storage frames as the layout elements included in the structured data, being selected.

With such a constitution, when the program stored in the storage medium is read by the computer, and the computer executes the processing in accordance with the read program, an action and an advantage equivalent to those in the template selection program of the twenty-second exemplary embodiment are obtained.

### Twenty-Seventh Exemplary Embodiment

A storage medium having stored therein a template selection program of a twenty-seventh exemplary embodiment is a computer readable storage medium having stored therein a template selection program to select a layout template that is used for laying out structured data in which plural layout elements are logically structured, storing a program to cause a computer, which is capable of using a template storing device that stores plural layout templates defining a layout in which plural information storage frames are arranged in a predetermined layout area, to execute processing, the program including a program for selecting the layout template from the template storing device; and a program for changing a logical structure of the layout template selected on the basis of a logical structure of the structured data, when it is judged that a layout template consistent with the logical structure of the structured data is not present in the template storing device, a layout template, which has the same number of information storage frames as the layout elements included in the structured data, is selected.

With such a constitution, when the program stored in the storage medium is read by the computer, and the computer executes the processing in accordance with the read program, an action and an advantage equivalent to those in the template selection program of the twenty-third exemplary embodiment are obtained.

### Twenty-eighth Exemplary Embodiment

On the other hand, in order to attain the object, a layout method of a twenty-eighth exemplary embodiment is a layout method of laying out structured data in which plural layout elements are logically structured, including: selecting a layout template defining a layout of plural information storage frames; changing a logical structure of the layout template selected on the basis of a logical structure of the structured data; and storing the layout elements, which are included in the structured data, in the information storage frames to perform layout in accordance with the changed layout template, a layout template, which has the information storage frames of a number identical with the number of the layout elements included in the structured data, being selected.

Consequently, an advantage equivalent to that in the layout system of the first exemplary embodiment is obtained.

### Twenty-Ninth Exemplary Embodiment

A layout method of a twenty-ninth exemplary embodiment is a layout method of laying out structured data in which plural layout elements are logically structured, including: selecting a layout template defining a layout, in which plural information storage frames are arranged in a predetermined layout area, from a template storing device having stored therein a plurality of the layout templates; changing a logical structure of the layout template selected on the basis of a logical structure of the structured data; and storing the layout elements, which are included in the structured data, in the information storage frames to perform layout in accordance with the changed layout template, when it is judged that a layout template consistent with the logical structure of the structured data is not present in the template storing device, a layout template, which has the same number of information storage frames as the layout elements included in the structured data, is selected.

Consequently, an advantage equivalent to that in the layout system of the second exemplary embodiment is obtained.

### Thirtieth Exemplary Embodiment

A layout method of a thirtieth exemplary embodiment includes, in the layout method of the twenty-ninth exemplary embodiment, at least one of attributes of the layout elements and attributes of information storage frames, in which the layout elements should be stored, being set for the layout elements, at least one of attributes of layout elements, which should be stored in the information storage frames, and attributes of the information storage frames being set in the information storage frames, and for each attribute of the layout elements included in the structured data, a layout template, which has the same number of information storage frames as the layout elements of the attribute included in the structured data, is selected.

Consequently, an advantage equivalent to that in the layout system of the third exemplary embodiment is obtained.

### Thirty-First Exemplary Embodiment

A layout method of a thirty-first exemplary embodiment includes, in the layout method of the twenty-ninth or the thirtieth exemplary embodiment, when it is judged that a layout template, which has the same number of information storage frames as the layout elements included in the structured data, is not present in the template storing device, a layout template, which has the closest number of the information storage frames to the layout elements included in the structured data, is selected.

Consequently, an advantage equivalent to that in the layout system of the fourth exemplary embodiment is obtained.

### Thirty-Second Exemplary Embodiment

A layout method of a thirty-second exemplary embodiment includes, in the layout method of the thirty-first exemplary embodiment, an information storage frame added to or deleted from a layout, which is defined by the layout template selected by the template selecting device, such that the number of the layout elements included in the structured data and the number of the information storage frames are identical with each other and, then, a logical structure of the layout template is changed.

Consequently, an advantage equivalent to that in the layout system of the fifth exemplary embodiment is obtained.

### Thirty-Third Exemplary Embodiment

A layout method of a thirty-third exemplary embodiment further including, in the layout method of any one of the twenty-ninth to the thirty second exemplary embodiments, adjusting arrangement positions and sizes of the information storage frames in the layout, which is defined by the changed layout template, on the basis of predetermined adjustment rules.

Consequently, an advantage equivalent to that in the layout system of the sixth exemplary embodiment is obtained.

### Thirty-Fourth Exemplary Embodiment

A layout method of a thirty-fourth exemplary embodiment includes, in the layout method of the thirty-third exemplary embodiment, that the predetermined adjustment rules are defined on the basis of design knowledge.

Consequently, an advantage equivalent to that in the layout system of the seventh exemplary embodiment is obtained.

### Thirty-Fifth Exemplary Embodiment

A layout method of a thirty-fifth exemplary embodiment is a layout method of laying out structured data in which plural layout elements are logically structured, including: selecting, with an arithmetic unit, a layout template defining a layout of plural information storage frames; changing, with the arithmetic unit, a logical structure of the layout template selected on the basis of a logical structure of the structured data; storing, with the arithmetic unit, the layout elements, which are included in the structured data, in the information storage frames to perform layout in accordance with the changed layout template, a layout template, which has the same number of information storage frames as the layout elements included in the structured data, is selected.

Consequently, an advantage equivalent to that in the layout system of the first exemplary embodiment is obtained.

### Thirty-Sixth Exemplary Embodiment

A layout method of a thirty-sixth exemplary embodiment is a layout method of laying out structured data in which plural layout elements are logically structured, including: selecting, with an arithmetic unit, a layout template defining a layout, in which plural information storage frames are arranged in a predetermined layout area, from a template storing device having stored therein a plurality of the layout templates; changing, with the arithmetic unit, a logical structure of the layout template selected on the basis of a logical structure of the structured data; and storing, with the arithmetic unit, the layout elements, which are included in the structured data, in the information storage frames to perform layout in accordance with the changed layout template, when it is judged that a layout template consistent with the logical structure of the structured data is not present in the template storing device, a layout template, which has the same number of information storage frames as the layout elements included in the structured data, is selected.

Consequently, an advantage equivalent to that in the layout system of the second exemplary embodiment is obtained.

### BRIEF DESCRIPTION OF THE DRAWINGS

FIG. 1 is a functional block schematic showing a functional outline of a layout apparatus in an exemplary embodiment;

FIG. 2 is a block schematic showing a hardware structure of the layout apparatus in an exemplary embodiment;

FIG. 3 is a schematic showing a logical structure of a structured document in an exemplary embodiment;

FIG. 4 is a table showing types of layout elements in an exemplary embodiment;

FIG. 5 is a schematic showing a data structure of the structured document in an exemplary embodiment;

FIG. 6 is a schematic showing a layout defined by a layout template in an exemplary embodiment;

FIG. 7 is a flowchart showing layout processing in an exemplary embodiment;

FIG. 8 is a flowchart showing template selection processing in an exemplary embodiment;

FIG. 9 is a flowchart showing template structure changing processing in an exemplary embodiment;

FIG. 10 is a flowchart showing automatic layout processing in an exemplary embodiment;

FIGS. 11A-11C are schematics showing an example of registration of a layout template in a template registration in an exemplary embodiment;

FIG. 12 is a schematic showing a second layout template obtained by changing a logical structure of a first layout template in an exemplary embodiment;

FIG. 13 is a functional block diagram schematic showing a functional outline of the layout apparatus in an exemplary embodiment;

FIGS. 14A and 14B are schematics showing adjustment rules that are defined on the basis of design knowledge in an exemplary embodiment;

FIGS. 15A-15C are schematics showing an example of registration of a layout template in the template registration database in an exemplary embodiment;

FIG. 16 is a schematic showing a case in which an information storage frame is added or deleted such that a layout template is consistent with the logical structure of the structured document in an exemplary embodiment;

FIG. 17 is a schematic showing a second layout template obtained by changing a logical structure of a first layout template in an exemplary embodiment;

FIG. 18 is a schematic showing a layout template obtained by adjusting information storage frames in an exemplary embodiment;

FIG. 19 is a table showing types of layout elements in an exemplary embodiment;

FIG. 20 is a schematic showing a data structure in the case in which style information is separated from a layout template; and

FIG. 21 is a schematic showing a storage medium and a data structure of the storage medium in an exemplary embodiment.

### DETAILED DESCRIPTION OF EMBODIMENTS

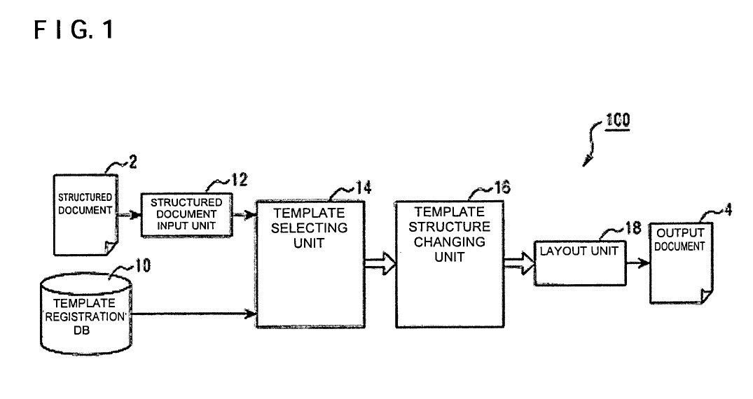

A first exemplary embodiment will be hereinafter explained with reference to the drawings. FIGS. 1 to 12 are schematics showing the first exemplary embodiment of a layout system, a layout apparatus, a layout program, a template selection program, a storage medium having stored therein the layout program, a storage medium having stored therein the template selection program, as well as a layout method in accordance with the exemplary embodiments.

First, a functional outline of a layout apparatus 100 to which the exemplary embodiments are applied will be explained in detail with reference to FIG. 1.

FIG. 1 is a functional block diagram showing the functional outline of the layout apparatus 100.

As shown in FIG. 1, the layout apparatus 100 includes a template registration database (database will be hereinafter abbreviated simply as DB) 10 that stores plural layout templates, a structured document input unit 12 that inputs a structured document 2 to be a layout object, a template selecting unit 14 that selects a layout template from the template registration DB 10, a template structure changing unit 16 that changes a logical structure of the layout template selected by the template selecting unit 14 on the basis of a logical structure of the structured document 2, and a layout unit 18 that lays out the structured document 2 in accordance with the layout template changed by the template structure changing unit 16 and outputs an output document 4.

The layout template defines a layout in which plural information storage frames are arranged in a predetermined layout area and can set the number, arrangement positions and sizes, as well as types of the information storage frames arbitrarily. A structure of the layout template will be described in detail later.

When it is judged that a layout template consistent with the logical structure of the structured document 2 is not present in the template registration DB 10, the template selecting unit 14 selects a layout template having the same number of the information storage frames as the layout elements included in the structured document 2.

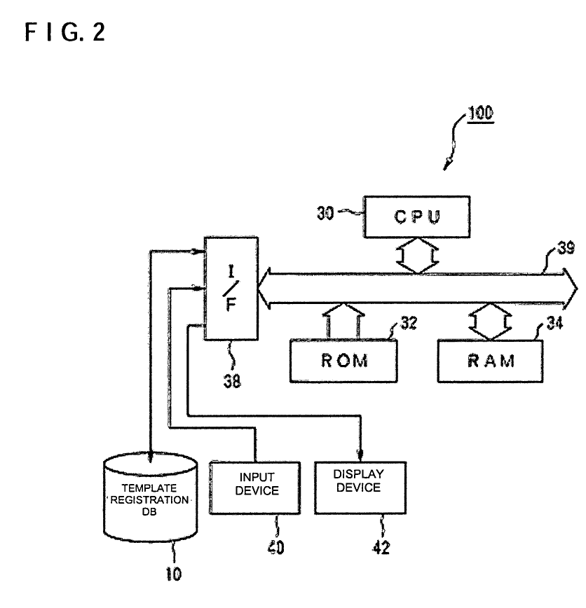

Next, a structure of the layout apparatus 100 will be explained with reference to FIGS. 2 to 10.

FIG. 2 is a block diagram showing a hardware structure of the layout apparatus 100.

As shown in FIG. 2, the layout apparatus 100 includes a CPU 30 that controls an arithmetic operation and an entire system on the basis of a control program, a ROM 32 that stores the control program and the like for the CPU 30 in a predetermined area in advance, a RAM 34 for storing data read out from the ROM 32 and a result of an arithmetic operation necessary in an arithmetic process of the CPU 30, and an I/F 38 that mediates input and output of data to and from external apparatuses. These units are connected to one another by a bus 39 serving as a data line for transferring data so as to be capable of exchanging the data.

A template registration DB 10, an input device 40 consisting of a keyboard, a mouse, or the like, which is capable of inputting data as a human interface, and a display device 42, which displays a screen on the basis of an image signal, are connected to the I/F 38 as the external apparatuses.

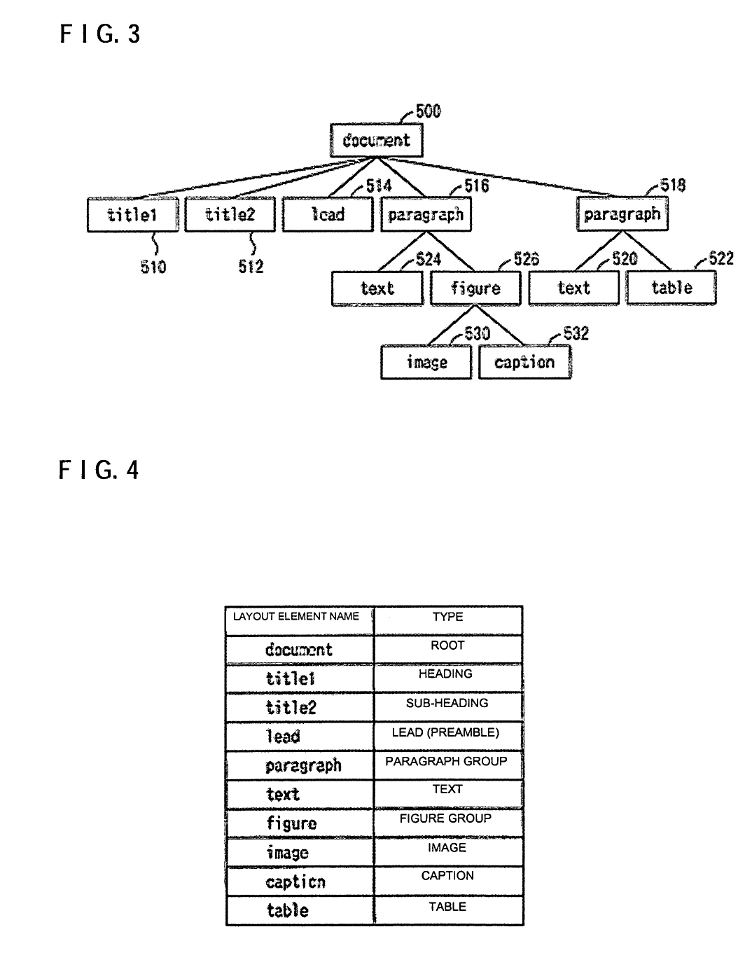

Next, a structure of the structured document 2 will be explained in detail with reference to FIGS. 3 to 5.

FIG. 3 is a schematic showing a logical structure of the structured document 2.

FIG. 4 is a table showing types of layout elements.

As shown in FIG. 3, the structured document 2 is document data that is constituted by hierarchically combining elements capable of constituting character information, image information, title information, and other layouts (hereinafter referred to as layout elements). The structured document 2 is written in a markup language such as XML. For example, when a certain article is displayed, in the case in which a related image is outputted together with the article, the structured document 2 is created by combining image information on the image corresponding to the article with a lower hierarchy of text data describing contents of the article. The structured document 2 is characterized in that information on a style of a document is excluded as much as possible and only logical information is included, whereby it is possible to realize various layouts from one document simply by changing a layout template to be applied (One-Source-Multi-Use).

As shown in FIG. 4, as the types of layout elements, there are a root, a heading, a sub-heading, a lead (preamble), a paragraph group, a text, a figure group, an image, a caption, and a table. Those are described as “document”, “title1”, “title2”, “lead”, “paragraph”, “text”, “caption”, and “table” in the structured document 2, respectively. Among them, the root indicates a top hierarchy. The paragraph group and the figure group indicate that the other layout elements are grouped. Both the paragraph group and the figure group define logical structures and are not reflected as outputs.

In the example of FIG. 3, a heading 510, a sub-heading 512, a lead 514, a paragraph group 516, and a paragraph group 518 belong to a hierarchy immediately below a root 500. A text 520 and a table 522 belong to a hierarchy immediately below the paragraph group 518. In addition, a text 524 and a figure group 526 belong to a hierarchy immediately below the paragraph group 516. An image 530 and a caption 532 belong to a hierarchy immediately below the figure group 526. The image 530 and the caption 532 constitute a related one figure, the figure and the text 524 constitute a related one paragraph, the text 520 and the table 522 constitute a related one paragraph, and the paragraphs, the heading 510, the sub-heading 512, and the lead 514 constitute the entire article.

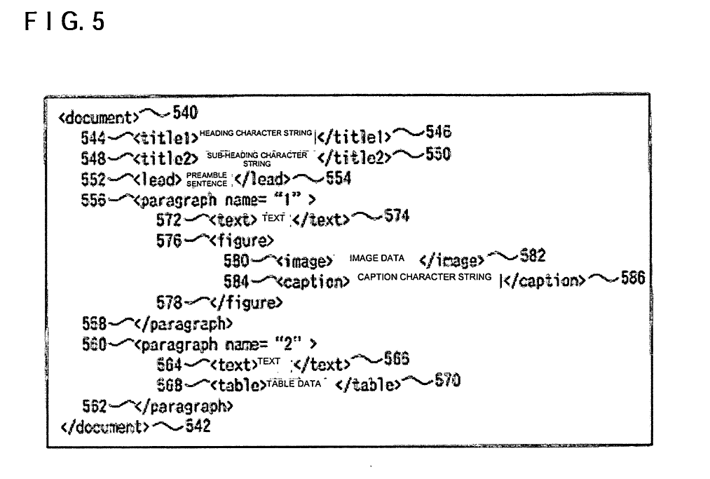

FIG. 5 is a schematic showing a data structure of the structured document 2.

As shown in FIG. 5, the structured document 2, having the logical structure of FIG. 3, sets layout elements by describing tag sets of a start tag and an end tag in a nesting shape between a start tag 540 and an end tag 542 for setting the root 500. Between the tag sets 540 and 542, first, a “heading character string” is described by tag sets 544 and 546 for setting the heading 510. This indicates that character information “heading character string” is set as the heading 510. Similarly, between the tag sets 540 and 542, a “sub-heading character string” is described by tag sets 548 and 550 for setting the sub-heading 512, and a “preamble” is described by tag sets 552 and 554 for setting the lead 514.

Between the tag sets 540 and 542, tag sets 556 and 558 for setting the paragraph group 516 and tag sets 560 and 562 for setting the paragraph group 518 are further described.

Between the tag sets 560 and 562, a “text” is described by tag sets 564 and 566 for setting the text 520. In addition, a “table data” is described by tag sets 568 and 570 for setting the table 522. This indicates that a table with a file name “table data” is referred to.

Between the tag sets 556 and 558, a “text” is described by tag sets 572 and 574 for setting the text 524, and tag sets 576 and 578 for setting the figure group 526 are described. Between the tag sets 576 and 578, “image data” is described by tag sets 580 and 582 for setting the image 530. This indicates that image data with a file name “image data” is referred to. In addition, a “caption character string” is described by tag sets 584 and 586 for setting the caption 532.

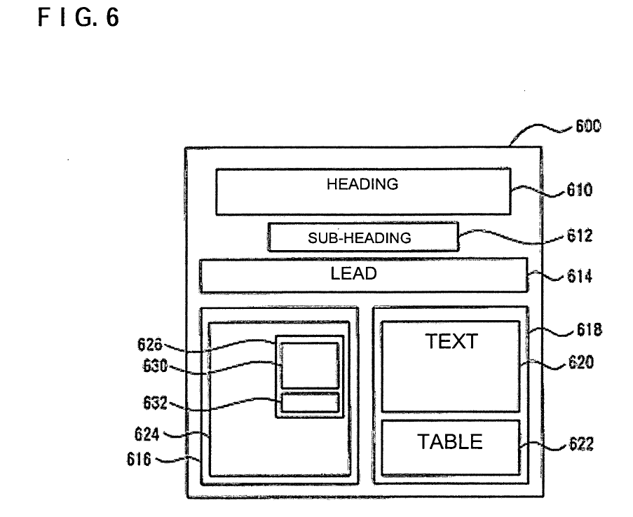

Next, a data structure of the template registration DB 10 will be explained in detail with reference to FIG. 6.

The template registration DB 10 registers plural layout templates defining a layout in association with file names thereof.

The layout template can set sizes, types, and colors of fonts of character information, character intervals and row pitches, and qualities, sizes, aspect ratios, and trimming of image information in addition to the number, arrangement positions, sizes, and types of information storage frames. The layout template is written in a markup language such as XML.

As the information storage frames, in association with types of the layout elements, there are a heading storage frame for storing a heading, a sub-heading storage frame for storing a sub-heading, a lead storage frame for storing a lead, a paragraph storage frame for storing a paragraph, a text storage frame for storing a text, a figure storage frame for storing a figure, an image storing frame for storing an image, a caption storage frame for storing a caption, and a table storage frame for storing a table.

Note that, although the respective layout templates have different data structures, a representative one of the layout templates will be explained here.

FIG. 6 is a diagram showing a layout defined by a layout template.

As shown in FIG. 6, the layout template defines a layout in which a heading storage frame 610, a sub-heading storage frame 620, a lead storage frame 614, and paragraph storage frames 616 and 618 are arranged in a layout area 600. The heading storage frame 610, the sub-heading storage frame 612, and the lead storage frame 614 are arranged in order from the top of the layout area 600. In addition, the paragraph storage frame 616 is arranged on the left below the lead storage frame 614, and the paragraph storage frame 618 is arranged on the right below the lead storage frame 614.

A text storage frame 620 and a table storage frame 622 are arranged in the paragraph storage frame 618. The text storage frame 620 and the table storage frame 622 are arranged in order from the top in the paragraph storage frame 618.

A text storage frame 624 and a figure storage frame 626 are arranged in the paragraph storage frame 616. The text storage frame 624 is arranged over an entire area of the paragraph storage frame 616, and the figure storage frame 626 is arranged on the right above the paragraph storage frame 616 to be superimposed on the text storage frame 624. An image storage frame 630 and a caption storage frame 632 are further arranged in the figure storage frame 626. The image storage frame 630 and the caption storage frame 632 are arranged in order from the top in the figure storage frame 626.

In the case in which the layout template of FIG. 6 is applied to the structured document 2 having the logical structure of FIG. 3, the heading 510, the sub-heading 512, and the lead 514 are stored in the heading storage frame 610, the sub-heading storage frame 612, and the lead storage frame 614, respectively. In addition, the texts 520 and 524, the table 522, the image 530, and the caption 532 are stored in the text storage frames 620 and 624, the table storage frame 622, the image storage frame 630, and the caption storage frame 632, respectively.

Note that, although a data structure of the layout template is not specifically illustrated, like the structured document 2, a layout format is set by describing tag sets between predetermined start tags and end tags in a nesting shape.

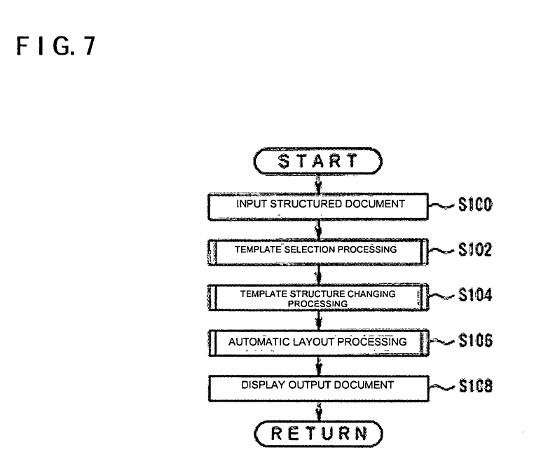

Next, a structure of the CPU 30 and processing executed by the CPU 30 will be explained with reference to FIG. 7.

The CPU 30 consists of a microprocessing unit (MPU) or the like and starts a predetermined program stored in a predetermined area of the ROM 32 to execute layout processing shown in a flowchart of FIG. 7 in accordance with the program.

FIG. 7 is a flowchart showing layout processing.

The layout processing is processing that is realized as the structured document input unit 12, the template selecting unit 14, the template structure changing unit 16, and the layout unit 18. When the layout processing is executed in the CPU 30, as shown in FIG. 7, first, the CPU 30 shifts to step S100.

In step S100, the CPU 30 inputs the structured document 2 to be a layout object, shifts to step S102, and executes template selection processing for selecting a layout template from the template registration DB 10. Then, the CPU 30 shifts to step S104, executes template structure changing processing for changing a logical structure of the selected layout template, and shifts to step S106.

In step S106, the CPU 30 executes automatic layout processing for laying out the structured document 2 in accordance with the layout template. Then, the CPU 30 shifts to step S108, displays the output document 4 obtained by laying out the structured document 2 on a display device 42, and ends the series of processing to return to the original processing.

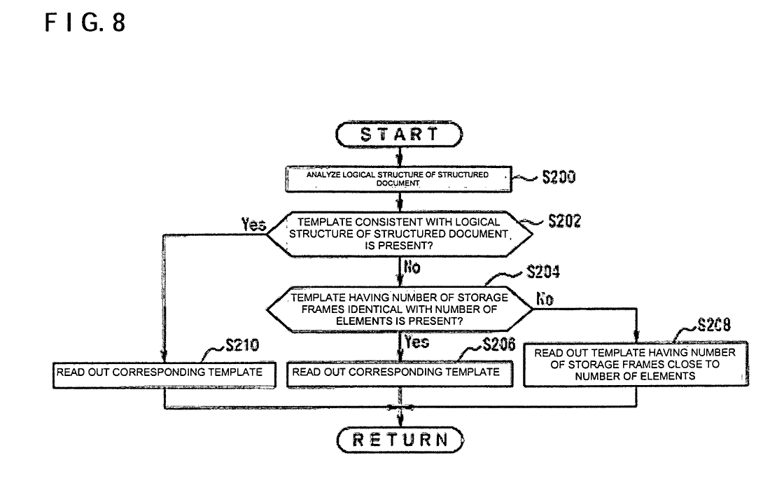

Next, the template selection processing in step S102 will be explained in detail with reference to FIG. 8.

FIG. 8 is a flowchart showing the template selection processing in step S102.

When the template selection processing is executed in step S102, as shown in FIG. 8, first, the CPU 30 shifts to step S200.

In step S200, the CPU 30 analyzes the logical structure of the structured document 2 inputted in step S100. Then, the CPU 30 shifts to step S202 and judges whether a layout template consistent with the logical structure of the structured document 2 is present in the template registration DB 10 on the basis of a result of the analysis in step S200. If it is judged that the corresponding layout template is not present (No), the CPU 30 shifts to step S204.

In step S204, for each type of layout elements and information storage frames, the CPU 30 judges whether a layout template, which has the number of information storage frames of the type identical with the number of layout elements of the type included in the structured document 2, is present in the template registration DB 10. If it is judged that the corresponding layout template is present (Yes), the CPU 30 shifts to step S206, reads out the corresponding layout template from the template registration DB 10, and ends the series of processing to return to the original processing.

On the other hand, if it is judged in step S204 that the corresponding layout template is not present (No), the CPU 30 shifts to step S208, reads out a layout template, which has the number of the information storage frames closest to the number of the layout elements included in the structured document 2, from the template registration DB 10, and ends the series of processing to return to the original processing.

On the other hand, if it is judged in step S202 that the corresponding layout template is present (Yes), the CPU 30 shifts to step S210, reads out the corresponding layout template from the template registration DB 10, and ends the series of processing to return to the original processing.

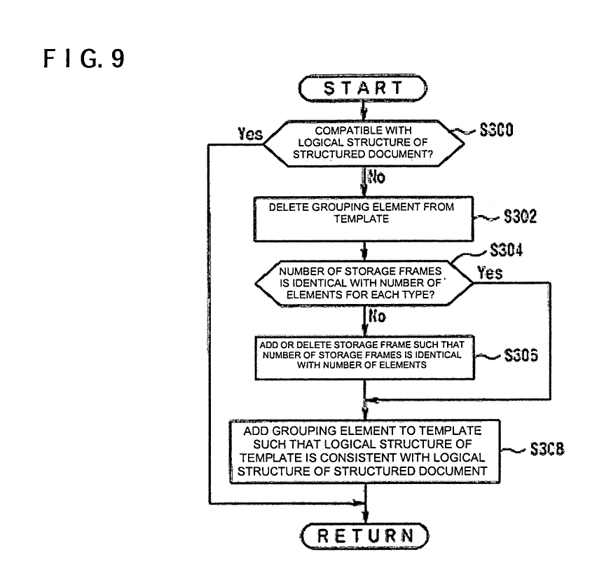

Next, the template structure changing processing in step S104 will be explained in detail with reference to FIG. 9.

FIG. 9 is a flowchart showing the template structure changing processing in step S104.

When the template structure changing processing is executed in step S104, as shown in FIG. 9, first, the CPU 30 shifts to step S300.

In step S300, the CPU 30 judges whether the layout template selected in step S102 (hereinafter referred to as selected layout template) is consistent with the logical structure of the structured document 2. If it is judged that the selected layout template is not consistent with the logical structure of the structured document 2 (No), the CPU 30 shifts to step S302, deletes a layout element for grouping layout elements into a paragraph group, a figure group, and the like (hereinafter referred to as grouping element) from the selected layout template, and shifts to step S304.

In step S304, the CPU 30 judges whether the number of the layout elements included in the structured document 2 and the number of information storage frames defined by the selected layout templates are identical with each other for each type. If it is judged that the numbers are not identical with each other in any one of the types (No), the CPU 30 shifts to step S306.

In step S306, the CPU 30 adds or deletes an information storage frame to or from the layout defined by the selected layout template such that the number of the layout elements included in the structured document 2 and the number of the information storage frames are identical with each other for each type. Then, the CPU 30 shifts to step S308, adds a grouping element to the selected layout template such that the logical structure of the structured document 2 and a logical structure of the selected layout template are consistent with each other, and ends the series of processing to return to the original processing.

On the other hand, if it is judged in step S304 that the number of the layout elements included in the structured document 2 and the number of information storage frames defined by the selected layout template are identical with each other for each type (Yes), the CPU 30 shifts to step S308.

On the other hand, if it is judged in step S300 that the selected layout template is consistent with the logical structure of the structured document 2 (Yes), the CPU 30 ends the series of processing to return to the original processing.

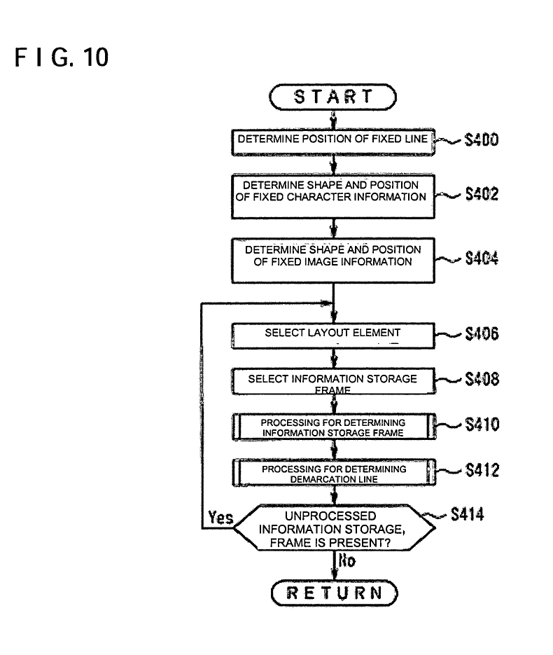

Next, the automatic layout processing in step S106 will be explained in detail with reference to FIG. 10.

FIG. 10 is a flowchart showing the automatic layout processing in step S106.

When the automatic layout processing is executed in step S106, as shown in FIG. 10, first, the CPU 30 shifts to step S400.

In step S400, the CPU 30 determines a position of a fixed line that is arranged fixedly in the layout area 600. The CPU 30 shifts to step S402 and determines a shape and a position of fixed character information that is arranged fixedly in the layout area 600. Then, the CPU 30 shifts to step S404, determines a shape and a position of fixed image information that is arranged fixedly in the layout area 600, and shifts to step S406.

In step S406, the CPU 30 selects one of the layout elements included in the structured document 2 and shifts to step S408.

In step S408, the CPU 30 selects one of information storage frames defined by the selected layout template on the basis of a type of the layout element selected in step S406 (hereinafter referred to as selected layout element), the logical structure of the structured document 2, and the logical structure of the selected layout template. More specifically, the CPU 30 selects an information storage frame that belongs a hierarchy identical with the selected layout element in terms of the logical structure and is the same type as the selected layout element. For example, in the case in which the selected layout element is a heading belonging to a top hierarchy in the structured document 2, the CPU 30 selects a heading storage frame belonging to a top hierarchy in the layout template.

Next, the CPU 30 shifts to step S410 and executes processing for determining an arrangement position or a shape of the information storage frame selected in step S408 (hereinafter referred to as selected information storage frame) on the basis of the selected layout element. In this determination processing, when the selected information storage frame is large compared with the selected layout element, the CPU reduces a size of the selected information storage frame to match the selected layout element. On the contrary, when the selected information storage frame is small compared with the selected layout element, the CPU 30 increases a size of the selected information storage frame to match the selected layout element. At this point, when the selected information storage frame overlaps another information storage frame due to the change of the size, the CPU 30 changes the arrangement position or the shape of the selected information storage frame not to overlap the another information storage frame. Then, the CPU 30 stores the selected layout element in the selected information storage frame after the change.

Subsequently, the CPU 30 shifts to step S412 and executes processing for determining a position of a demarcation line. Then, the CPU 30 shifts to step S414, judges whether an unprocessed information storage frame is present in the layout area 600, and if it is judged that no unprocessed information storage frame is present (No), ends the series of processing to return to the original processing.

On the other hand, if it is judged in step S414 that an unprocessed information storage frame is present in the layout area 600 (Yes), the CPU 30 shifts to step S406.

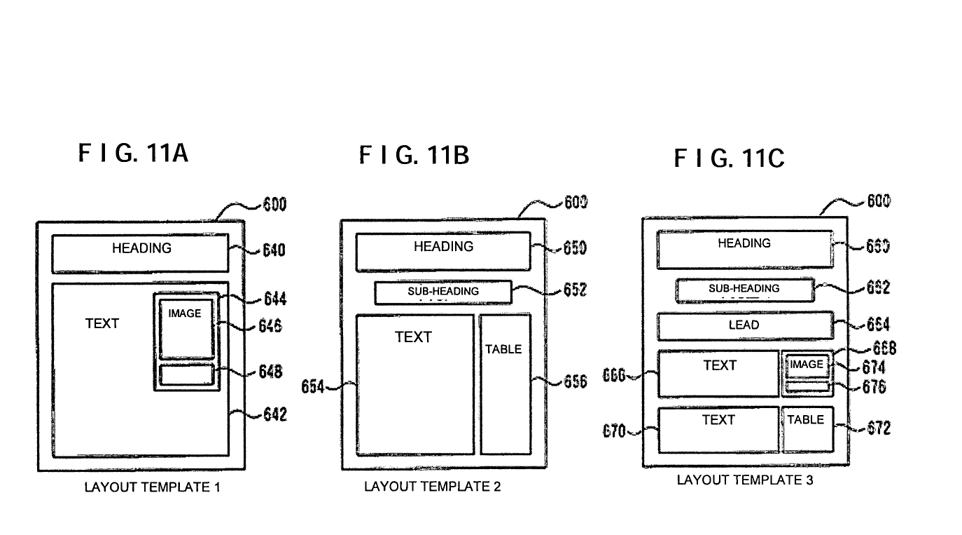

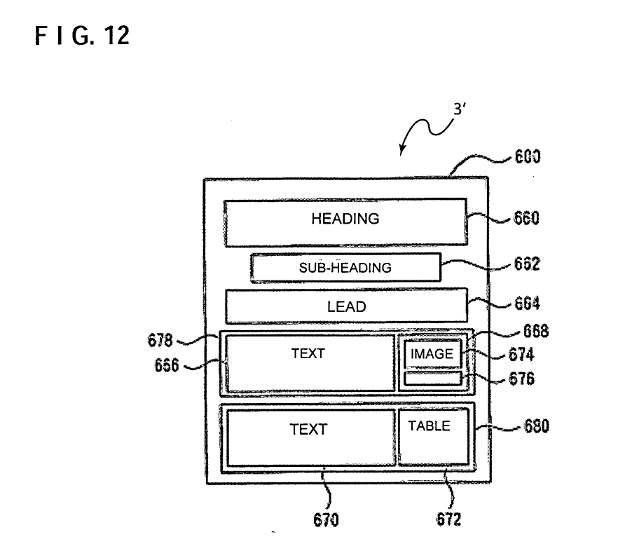

Next, an operation in this embodiment will be explained with reference to FIGS. 11A-11C and 12.

The operation will be explained with a case in which the structured document 2 having the logical structure of FIG. 3 is laid out as an example.

FIGS. 11A-11C are schematics showing an example of registration of a layout template in the template registration DB 10.

As shown in FIGS. 11A-11C, it is assumed that three layout templates 1, 2 and 3 are registered in the template registration DB 10. Note that, although a larger number of layout templates are registered actually, here, the number of registered layout templates is set to three for simplification of the explanation.

As shown in FIG. 11A, the layout template 1 defines a layout in which a heading storage frame 640 and a text storage frame 642 are arranged in the layout area 600. The heading storage area 640 and the text storage frame 642 are arranged in order from the top of the layout area 600. A figure storage frame 644 is arranged on the upper right in the text storage frame 642. An image storage frame 646 and a caption storage frame 648 are arranged in order from the top in the figure storage frame 644.

As shown in FIG. 11B, the layout template 2 defines a layout in which a heading storage frame 650, a sub-heading storage frame 652, a text storage frame 654, and a table storage frame 656 are arranged in the layout area 600. The heading storage area 650 and the sub-heading storage frame 652 are arranged in order from the top of the layout area 600. The text storage frame 654 and the table storage frame 656 are arranged on the left and the right below the sub-heading storage frame 652, respectively.

As shown in FIG. 11C, the layout template 3 defines a layout in which a heading storage frame 660, a sub-heading storage frame 662, a lead storage frame 664, text storage frames 666 and 670, a figure storage frame 668, and a table storage frame 672 in the layout area 600. The heading storage frame 660, the sub-heading storage frame 662, and the lead storage frame 664 are arranged in order from the top of the layout area 600. In addition, the text storage frame 666 and the figure storage frame 668 are arranged on the left and the right below the lead storage frame 664, respectively. The text storage frame 670 and the table storage frame 672 are arranged below the text storage frame 666 and the figure storage frame 668, respectively. The image storage frame 674 and the caption storage frame 676 are arranged in order from the top in the figure storage frame 668.

In the layout apparatus 100, when the structured document 2 having the logical structure of FIG. 3 is inputted as a layout object, through steps S200 and S202, a logical structure of the inputted structured document 2 is analyzed and it is judged whether a layout template consistent with the logical structure of the structured document 2 is present in the template registration DB 10 on the basis of a result of the analysis. It is seen from FIG. 3 and FIGS. 11A to 11C that a layout template consistent with the logical structure of the structured document 2 is not present in the template registration DB 10. Therefore, it is judged that a layout template consistent with the logical structure of the structured document 2 is not present.

Subsequently, through steps S204, for each type of layout elements or information storage frames, it is judged whether a layout template, which has the number of information storage frames of the type identical with the number of layout elements of the type included in the structured document 2, is present in the template registration DB 10. As shown in FIG. 3, the structured document 2 includes one heading, one sub-heading, one lead, two texts, one image, one caption, and one table. On the other hand, as shown in FIG. 11C, the layout template 3 defines one heading storage frame, one sub-heading storage frame, one lead storage frame, two text storage frames, one image storage frame, one caption storage frame, and one table storage frame. Therefore, since the layout template 3 corresponds to the layout template, it is judged that a corresponding layout template is present. Then, through step S206, the layout template 3 is read out from the template registration DB 10.

In the layout apparatus 100, when the layout template 3 is selected, through step S300, it is judged whether the layout template 3 is consistent with the logical structure of the structured document 2. As a result, since it is judged that the layout template 3 is not consistent with the logical structure of the structured document 2, through step S302, the grouping element is deleted from the layout template 3. More specifically, the figure storage frame 668 is deleted from the layout template 3.

Subsequently, through step S304, it is judged whether the number of the layout elements included in the structured document 2 and the number of information storage frames defined by the layout template 3 are identical with each other for each type. As a result, since it is judged the numbers for each type are identical with each other, through step S308, a grouping element is added to the layout template 3 such that the logical structure of the structured document 2 and the logical structure of the layout template 3 are consistent with each other. More specifically, two paragraph storage frames and one figure storage frame are added, whereby a layout template 3′ shown in FIG. 12 is obtained.

FIG. 12 is a schematic showing the layout template 3′ obtained by changing the logical structure of the layout template 3.

In the layout template 3′, as shown in FIG. 12, the heading storage frame 660, the sub-heading storage frame 662, the lead storage frame 664, and paragraph storage frames 678 and 680 are arranged in the layout area 600. The text storage frame 666 and the figure storage frame 668 are arranged in order from the left in the paragraph storage frame 678. The text storage frame 670 and the table storage frame 672 are arranged in order from the left in the paragraph storage frame 680. The image storage frame 674 and the caption storage frame 676 are arranged in order from the top in the figure storage frame 668.

In the layout apparatus 100, when the layout template 3′ is obtained by the change of the logical structure, through steps S406 to S410, one of the layout elements included in the structured document 2 is selected, an information storage frame, which belongs to a hierarchy identical with the selected layout element and is the same type as the selected layout element, is selected from information storage frames defined by the layout template 3′, and the selected layout element is stored in a selected information storage frame. Such processing is performed for all the information storage frames of the layout area 600 repeatedly through steps S406 to S412. As a result, the heading 510 is stored in the heading storage frame 660, the sub-heading 512 is stored in the sub-heading storage frame 662, the lead 514 is stored in the lead storage frame 664, the text 524 is stored in the text storage frame 666, the image 530 is stored in the image storage frame 674, the caption 532 is stored in the caption storage frame 676, the text 520 is stored in the text storage frame 670, and the table 522 is stored in the table storage frame 672.

In the layout apparatus 100, when the automatic layout processing is completed, through step S108, the output document 4 obtained by laying out the structured document 2 is displayed on the display device 42.

Note that, in the layout apparatus 100, for each type of layout element or information storage frames, when it is judged that a layout template, which has the number of information storage frames of the type identical with the number of layout elements of the type included in the structured document 2, is not present in the template registration DB 10, through step S208, a layout template, which has the number of information storage frames closest to the number of the layout elements included in the structured document 2, is read out from the template registration DB 10. Then, through steps S306 and S308, an information storage frame is added to or deleted from the layout defined by the selected layout template such that the number of the layout elements included in the structured document 2 and the number of the information storage frames are identical with each other for each type, and a grouping element is added to the selected layout template such that the logical structure of the structured document 2 and the logical structure of the selected layout template are consistent with each other.

In addition, in the layout apparatus 100, when it is judged that a layout template consistent with the logical structure of the structured document 2 is present in the template registration DB 10, through step S210, the corresponding layout template is read out from the template registration DB 10 and the automatic layout processing is performed.

In this way, in this embodiment, when it is judged that a layout template consistent with the logical structure of the structured document 2 is not present, a layout template, which has the information storage frames of a number identical with the number of the layout elements included in the structured document 2, is selected, a logical structure of the selected layout template is changed on the basis of the logical structure of the structured document 2, and the layout elements included in the structured document 2 are stored in the information storage frames in accordance with the changed layout template to perform layout.

Consequently, since the structured document 2 is laid out in accordance with the layout template, it is possible to use an existing layout and realize a layout that is relatively attractive compared with that in the past. In addition, even if a layout template consistent with the logical structure of the structured document 2 is not present, since a logical structure of a layout template close to the logical structure of the structured document 2 is changed to be used, it is possible to improve usability of the existing layout compared with that in the past.

In this embodiment, for each type of the layout elements included in the structured document 2, a layout template, which has the number of information storage frames of the type identical with the number of layout elements of the type included in the structured document 2, is selected.

Consequently, since a logical structure of a layout template closer to the logical structure of the structured document 2 is changed to be used, it is possible to realize a more attractive layout.

In this exemplary embodiment, when it is judged that a layout template, which has the information storage frames of a number identical with the number of the layout elements included in the structured document 2, is not present, a layout template, which has the closest number of the information storage frames to the layout elements included in the structured document 2, is selected.

Consequently, even if a layout template, which has the same number of information storage frames as the layout elements included in the structured document 2, is not present, since a logical structure of a layout template close to the logical structure of the structured document 2 is changed to be used, it is possible to further improve usability of an existing layout.

In this exemplary embodiment, an information storage frame is added to or deleted from a layout defined by the selected layout template such that the number of the layout elements included in the structured document 2 and the number of the information storage frames are identical with each other and, then, a logical structure of the layout template is changed.

Consequently, since an information storage frame is added or deleted such that the layout template is consistent with the logical structure of the structured document 2 and, then, a logical structure of the layout template is changed, it is possible to realize a more attractive layout.

In the first exemplary embodiment, the template registration DB 10 corresponds to the template storing device of the second, the fourth, the ninth, the eleventh, the sixteenth, the eighteenth, the twenty-third, the twenty-fifth, the twenty-seventh, the twenty-ninth, the thirty-first, or the thirty sixth exemplary embodiment, the CPU 30 corresponds to the arithmetic unit of the thirty-fifth or the thirty-sixth exemplary embodiment, and the structured document 2 corresponds to the structured data of the first to the fifth, the eighth to the twelfth, the fifteenth to the nineteenth, the twenty-second to the thirty-second, the thirty-fifth, or the thirty-sixth exemplary embodiment. In addition, the template selecting unit 14 and steps S200 to S210 correspond to the template selecting device of the first to the fifth or the eighth to the twelfth exemplary embodiments and steps S200 to S210 correspond to the template selecting of the fifteenth to the nineteenth, the twenty-second to the thirty-second, the thirty-fifth, or the thirty-sixth exemplary embodiment.

In the first exemplary embodiment, the template structure changing unit 16 and steps S300 to S308 correspond to the template structure changing device of the first, the second, the fifth, the eighth, the ninth, or the twelfth exemplary embodiments and steps S300 to S308 correspond to the template structure changing of the fifteenth, the sixteenth, the nineteenth, the twenty-second to the twenty-ninth, the thirty-second, the thirty-fifth, or the thirty sixth exemplary embodiments. In addition, the layout unit 18 and steps S400 to S414 correspond to the layout device of the first, the second, the eighth, or the ninth exemplary embodiments and steps S400 to S414 correspond to the layout steps of the fifteenth, the sixteenth, the twenty-fourth, the twenty-fifth, the twenty-eighth, the twenty-ninth, the thirty-fifth, or the thirty-sixth exemplary embodiments.

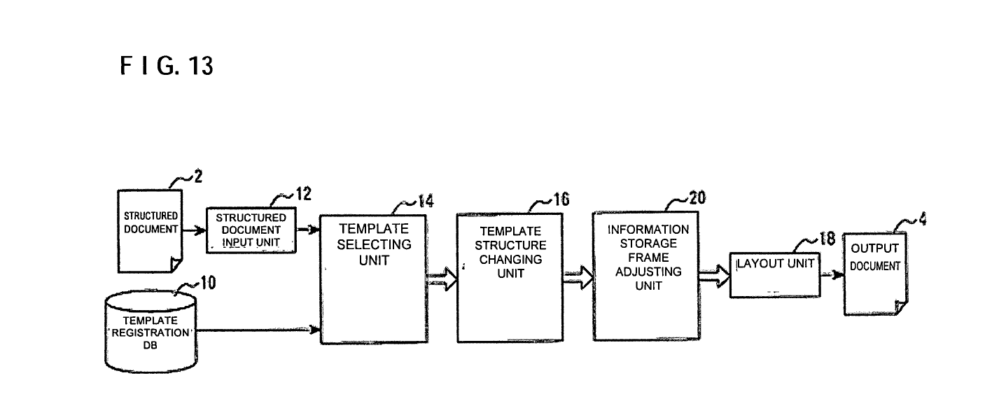

Next, a second exemplary embodiment will be explained with reference to the drawings. FIGS. 13 to 18 are schematics showing the second exemplary embodiment of the layout system, the layout apparatus, the layout program, the template selection program, the storage medium having stored therein the layout program, the storage medium having stored therein the template selection program, as well as the layout method in accordance with the exemplary embodiments.

In this exemplary embodiment, the layout system, the layout apparatus, the layout program, the template selection program, the storage medium having stored therein the layout program, the storage medium having stored therein the template selection program, as well as the layout method in accordance with the exemplary embodiment are applied to a case in which the structured document 2 is automatically laid out in accordance with a layout template. This exemplary embodiment is different from the first exemplary embodiment in that arrangement positions and sizes of information storage frames are adjusted. Note that only differences from the first exemplary embodiment will be hereinafter explained, and parts duplicating those in the first exemplary embodiment will be denoted by the identical reference numerals and signs and explanations of the parts will be omitted.

First, a functional outline of the layout apparatus 100 to which the exemplary embodiments are applied will be explained in detail with reference to FIG. 13.

FIG. 13 is a functional block schematic showing the functional outline of the layout apparatus 100.

As shown in FIG. 13, the layout apparatus 100 includes the template registration DB 10, the structured document input unit 12, the template selecting unit 14, the template structure changing unit 16, an information storage frame adjusting unit 20 that adjusts arrangement positions and sizes of information storage frames in a layout that is defined by a layout template changed by the template structure changing unit 16, and the layout unit 18 that lays out the structured document 2 in accordance with the layout template adjusted by the information storage frame adjusting unit 20 and outputs the output document 4.

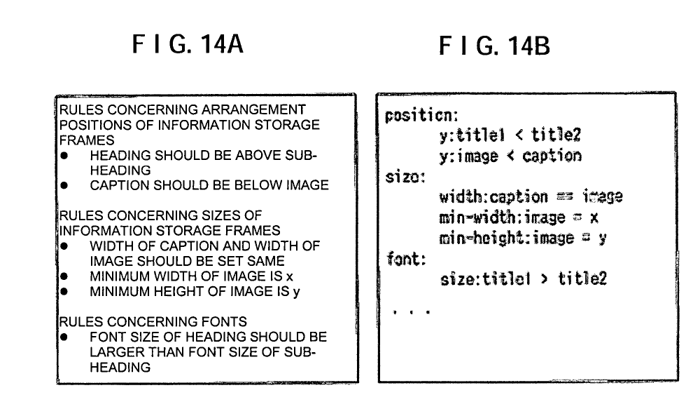

FIGS. 14A and 14B are schematics showing adjustment rules that are defined on the basis of design knowledge.

The information storage frame adjusting unit 20 adjusts arrangement positions and sizes of information storage frames on the basis of predetermined adjustment rules. The adjustment rules include rules concerning the arrangement positions of the information storage frames, rules concerning the sizes of the information storage frames, and rules concerning fonts. These rules are defined on the basis of design knowledge.

As the arrangement position rules, as shown in FIG. 14A, for example, rules such as “heading should be arranged above sub-heading” and “caption should be arranged below image” are defined. When the rules are described in a format interpretable by the layout apparatus 10, as shown in FIG. 14B, an item name “position:” is attached to the rules and, for example, a description “y:title1<title2” is placed below the item. This indicates that a heading is arranged above a sub-heading.

As the size rules, as shown in FIG. 14A, for example, rules “width of a caption and width of image should be set same”, “minimum width of image is x”, and “minimum height of image is y” are defined. When the rules are described in a format interpretable by the layout apparatus 100, as shown in FIG. 14B, an item name “size:” is attached to the rules and, for example, a description “width:caption==image” is placed below the item. This indicates that a width of a caption and a width of an image are set identical.

As the font rules, as shown in FIG. 14A, for example, a rule “font size of heading should be larger than font size of sub-heading” is defined. When the rule is described in a format interpretable by the layout apparatus 100, as shown in FIG. 14B, an item name “font:” is attached to the rule and, for example, a description “size:title1>title2” is placed below the item. This indicates that a font size of a heading is set larger than a font size of a sub-heading.

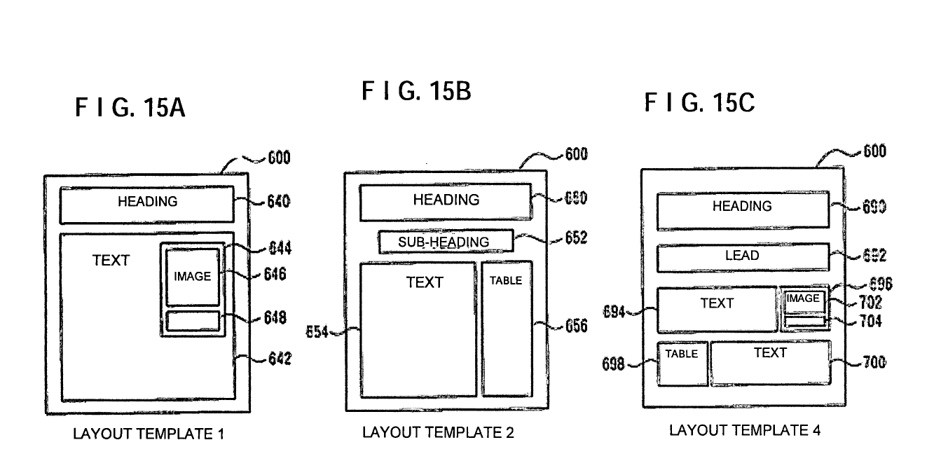

Next, an operation in this embodiment will be explained with reference to FIGS. 15A-18.

The operation will be explained with a case in which the structured document 2 having the logical structure of FIG. 3 is laid out as an example.

FIGS. 15A-15C are schematics showing an example of registration of a layout template in the template registration DB 10.

As shown in FIGS. 15A-15C, it is assumed that a layout template 4 is registered in the template registration DB 10 other than the layout templates 1 and 2 in FIG. 11.

As shown in FIG. 15C, the layout template 4 defines a layout in which a heading storage frame 690, a lead storage frame 692, text storage frames 694 and 700, a figure storage frame 696, and a table storage frame 698 are arranged in the layout area 600. The heading storage frame 690 and the lead storage frame 692 are arranged in order from the top of the layout area 600. In addition, the text storage frame 694 and the figure storage frame 696 are arranged on the left and the right below the lead storage frame 692, respectively. The table storage frame 698 and the text storage frame 700 are arranged below the text storage frame 694 and the figure storage frame 696, respectively. An image storage frame 702 and the caption storage frame 704 are arranged in order from the top in the figure storage frame 696.

In the layout apparatus 100, when the structured document 2 having the logical structure of FIG. 3 is inputted as a layout object, through steps S200 and S202, the logical structure of the inputted structured document 2 is analyzed, and it is judged whether a layout template consistent with the logical structure of the structured document 2 is present in the template registration DB 10 on the basis of a result of the analysis. It is seen from FIG. 3 and FIGS. 15A to 15C that a layout template consistent with the logical structure of the structured document 2 is not present in the template registration DB 10. Therefore, it is judged that a layout template consistent with the logical structure of the structured document 2 is not present.

Subsequently, through step S204, for each type of layout elements and information storage frames, it is judged whether a layout template, which has the number of information storage frames of the type identical with the number of layout elements of the type included in the structured document 2, is present in the template registration DB 10. It is seen from FIG. 3 and FIGS. 15A to 15C that a layout template, which has the information storage frames of a number identical with the number of layout elements for each type, is not present in the template registration DB 10. Therefore, it is judged that a layout template, which has the same number of information storage frames as the number of layout elements, is not present.

Subsequently, through step S208, a layout template, which has the number of information storage frames closest to the number of the layout elements included in the structured document 2, is read out from the template registration DB 10. As shown in FIG. 3, the structured document 2 includes one heading, one sub-heading, one lead, two texts, one image, one caption, and one table. On the other hand, as shown in FIG. 15C, the layout template 4 defines one heading storage frame, one lead storage frame, two text storage frames, one image storage frame, one caption storage frame, and one table storage frame. Therefore, since the layout template 4 is closest to the structured document 2, the layout template 4 is read out.

In the layout apparatus 100, when the layout template 4 is selected, through step S300, it is judged whether the layout template 4 is consistent with the logical structure of the structured document 2. As a result, since it is judged that the layout template 4 is not consistent with the logical structure of the structured document 2, through step S302, a grouping element is deleted from the layout template 4. More specifically, the figure storage frame 696 is deleted from the layout template 4.

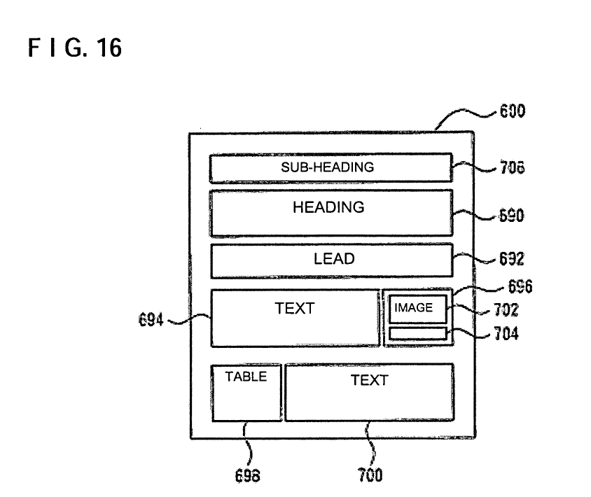

FIG. 16 is a schematic showing a case in which an information storage frame is added or deleted such that the layout template 4 is consistent with the logical structure of the structured document 2.

Subsequently, through step S304, it is judged whether the number of the layout elements included in the structured document 2 and the number of the information storage frames defined by the layout template 4 are identical with each other for each type. As a result, since it is judged that the numbers for each type are not identical with each other, through step S306, an information storage frame is added to or deleted from a layout defined by the layout template 4 such that the number of the layout elements included in the structured document 2 and the number of the information storage frames are identical with each other for each type. More specifically, since the layout template 4 lacks a sub-heading storage frame, a sub-heading storage frame 706 is added. Since there is a margin area in the upper part of the layout area 600 in the layout template 4, as shown in FIG. 16, the sub-heading frame 706 is added in the upper part of the layout area 600. Note that a style setting such as a font of the sub-heading storage frame 706 only has to be obtained by an arbitrary method. For example, it is possible that a default setting is prepared in advance and a value of the default setting is applied or the same setting as the style of the heading storage frame 690 is applied for convenience purpose.

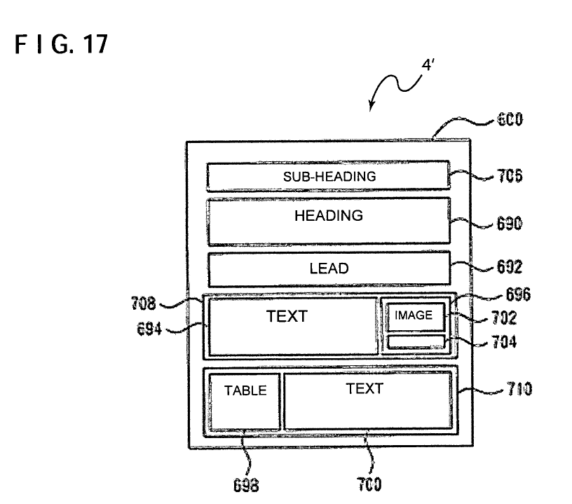

Subsequently, through step S308, a grouping element is added to the layout template 4 such that the logical structure of the structured document 2 and the logical structure of the layout template 4 are consistent with each other. More specifically, two paragraph storage frames and one figure storage frames are added, whereby a layout template 4′ shown in FIG. 17 is obtained.

FIG. 17 is a schematic showing the layout template 4′ obtained by changing the logical structure of the layout template 4.

In the layout template 4′, as shown in FIG. 17, the sub-heading storage frame 706, the heading storage frame 690, the lead storage frame 692, and paragraph storage frames 708 and 710 are arranged in the layout area 600. The text storage frame 694 and the figure storage frame 696 are arranged in order from the left in the paragraph storage frame 708. The table storage frame 698 and the text storage frame 700 are arranged in order from the left in the paragraph storage frame 710. The image storage frame 702 and the caption storage frame 704 are arranged in order from the top in the figure storage frame 696.

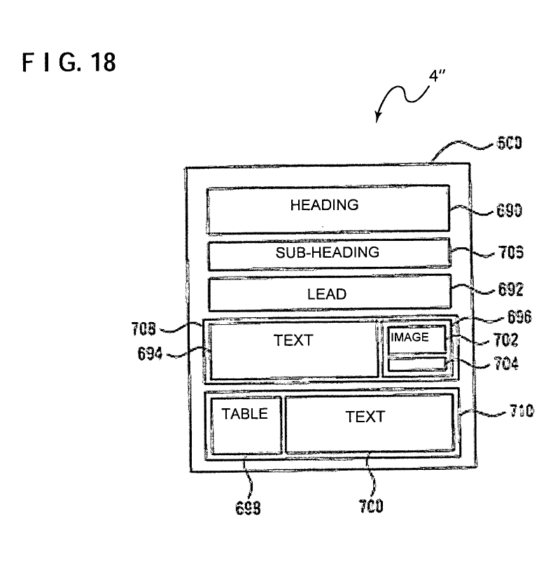

In the layout apparatus 100, when the layout template 4′ is obtained by the change of the logical structure, arrangement positions and sizes of information storage frames are adjusted in a layout defined by the layout template 4′ on the basis of adjustment rules. More specifically, since the sub-heading storage frame 706 is arranged above the heading storage frame 690, an arrangement position rule “A heading should be arranged above a sub-heading” is referred to, and an arrangement position of the sub-heading storage frame 706 and an arrangement position of the heading storage frame 690 are interchanged. In addition, when a font size of the sub-heading storage frame 706 is larger than a font size of the heading storage frame 690, a font rule “A font size of a heading should be larger than a font size of a sub-heading” is referred to, and the font size of the sub-heading storage frame 706 is set smaller than the font size of the heading storage frame 690. As a result, a layout template 4″ shown in FIG. 18 is obtained.

FIG. 18 is a schematic showing the layout template 4″ obtained by adjusting information storage frames.

In the layout apparatus 100, when the layout template 4″ is obtained by the adjustment of the information storage frames, through steps S406 to S410, the heading 510 is stored in the heading storage frame 690, the sub-heading 512 is stored in the sub-heading storage frame 706, the lead 514 is stored in the lead storage frame 692, the text 524 is stored in the text storage frame 694, the image 530 is stored in the image storage frame 702, the caption 532 is stored in the caption storage frame 704, the table 522 is stored in the table storage frame 698, and the text 520 is stored in the text storage frame 700.

In the layout apparatus 100, when the automatic layout processing is completed, through step S108, the output document 4 obtained by laying out the structured document 2 being displayed on the display device 42.

In this way, in this exemplary embodiment, arrangement positions and sizes of information storage frames are adjusted in a layout defined by a layout template with a changed logical structure on the basis of adjustment rules that are defined on the basis of design knowledge.

Consequently, since the arrangement positions and the sizes of the information storage frames are adjusted on the basis of the design knowledge, it is possible to realize a more attractive layout.

In the second exemplary embodiment, the template registration DB 10 corresponds to the template storing device of the second, the fourth, the ninth, the eleventh, the sixteenth, the eighteenth, the twenty-third, the twenty-fifth, the twenty-seventh, the twenty-ninth, the thirty-first, or the thirty sixth exemplary embodiments, the CPU 30 corresponds to the arithmetic unit of the thirty-fifth or the thirty-sixth exemplary embodiment, and the structured document 2 corresponds to the structured data of the first to the fifth, the eighth to the twelfth, the fifteenth to the nineteenth, the twenty-second to the thirty-second, the thirty-fifth, or the thirty-sixth exemplary embodiments. In addition, the template selecting unit 14 and steps S200 to S210 correspond to the template selecting device of the first to the fifth or the eighth to the twelfth inventions and steps S200 to S210 correspond to the template selecting step of the fifteenth to the nineteenth, the twenty-second to the thirty-second, the thirty-fifth, or the thirty-sixth exemplary embodiments.

In the second exemplary embodiment, the template structure changing unit 16 and steps S300 to S308 correspond to the template structure changing device of the first, the second, the fifth, the sixth, the eighth, the ninth, the twelfth, or the thirteenth exemplary embodiment and steps S300 to S308 correspond to the template structure changing step of the fifteenth, the sixteenth, the nineteenth, the twentieth, the twenty-second to the twenty-ninth, the thirty-second, the thirty-third, the thirty-fifth, or the thirty sixth exemplary embodiment. In addition, the layout unit 18 and steps S400 to S414 correspond to the layout device of the first, the second, the eighth, or the ninth exemplary embodiment and steps S400 to S414 correspond to the layout step of the fifteenth, the sixteenth, the twenty-fourth, the twenty-fifth, the twenty-eighth, the twenty-ninth, the thirty-fifth, or the thirty-sixth exemplary embodiment.

Note that, in the first and the second exemplary embodiments, when it is judged that a layout template consistent with the logical structure of the structured document 2 is not present, a layout template, which has the same number of information storage frames as the layout elements included in the structured document 2, is selected. However, the exemplary embodiment is not limited to this, and it is also possible to select a layout template on the basis of other judgment criteria. For example, the following three constitutions can be proposed.

As a first constitution, categories are set for the structured document 2 and the layout template, respectively. When it is judged that the layout template is consistent with the logical structure of the structured document 2 but is not consistent with the category of the structured document 2, a layout template, which has the information storage frames of a number identical with the number of the layout elements included in the structured document 2, is selected.

As a second constitution, when it is judged that the layout template is consistent with the logical structure of the structured document 2 but inappropriate for a resolution of an image included in the structured document 2, a layout template, which has the same number of information storage frames as the layout elements included in the structured document 2, is selected. For example, a case in which an image of a low resolution is stored in a large image storage frame corresponds to this constitution.

As a third constitution, when it is judged that, although layout is perform in accordance with a layout template consistent with the logical structure of the structured document 2, a desired layout is not obtained, a layout template, which has the same number of information storage frames as the layout elements included in the structured document 2, is selected.

Even with such a constitution, since a logical structure of a layout template close to the logical structure of the structured document 2 is changed to be used, it is possible to improve usability of an existing layout compared with that in the past.

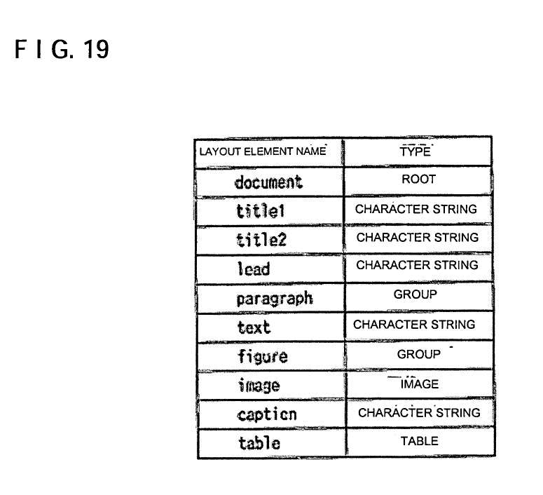

In addition, in the first and the second exemplary embodiments, as shown in FIG. 4, a root, a heading, a sub-heading, a lead, a paragraph group, a text, a figure group, an image, a caption, and a table are set as types of layout elements. However, the exemplary embodiments are not limited to this and, as shown in FIG. 19, it is also possible to set types not including a logical structure such as a character string, an image, an illustration, and a table.

FIG. 19 is a table showing types of layout elements.

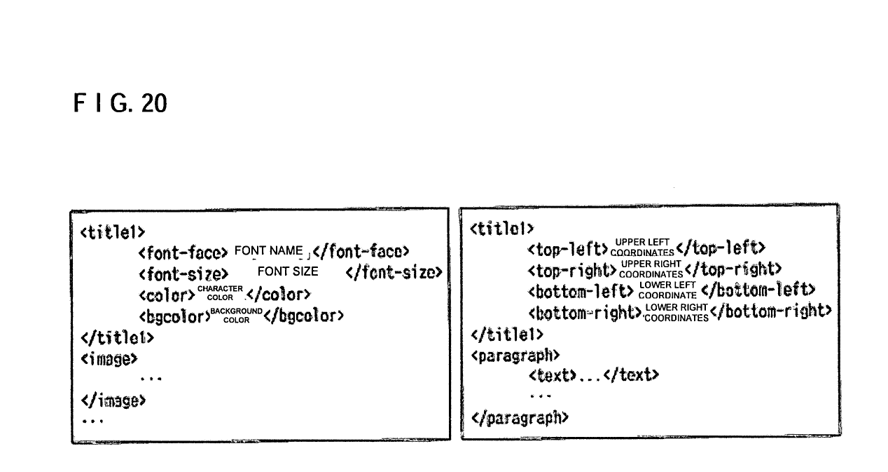

In the first and the second exemplary embodiments, as style information, attributes such as a type of a font, a character size, a color of a character, a color of a background, and character alignment are set in an information storage frame when the information storage frame is a character information storage frame for storing character information. When the information storage frame is an image information storage frame for storing an image and an illustration, attributes such as a quality, a size, an aspect ratio, trimming, and the like of image information are set in the information storage frame. However, the exemplary embodiments are not limited to this and, as shown in FIG. 20, it is also possible to separate such style information from a layout template and manage the style information.

FIG. 20 is a diagram showing a data structure in the case in which style information is separated from a layout template.

In the first and the second exemplary embodiments, the template registration DB 10 is provided as an external device of the layout apparatus 100. However, the exemplary embodiments are not limited to this, and it is also possible to provide the template registration DB 10 in an arbitrary terminal on a network and connect the layout apparatus 100 and the terminal using the network such that the layout apparatus 100 uses the template registration DB 10 of the terminal.

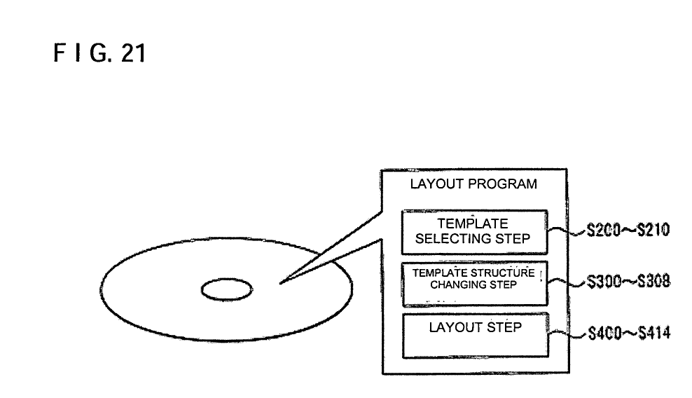

In addition, in the first and the second exemplary embodiments, concerning the execution of the processing shown in all the flowcharts of FIGS. 7, 8, 9, and 10, the case in which the control program stored in the ROM 32 in advance is executed is explained. However, the exemplary embodiment is not limited to this and, as shown in FIG. 21, a program indicating these procedures may be read in the RAM 34 from a storage medium having stored therein the program and executed.

FIG. 21 is a diagram showing a storage medium and a data structure of the storage medium.

Here, the storage medium is a semiconductor storage medium such as a RAM or a ROM, a magnetic storage type storage medium such as an FD or an HD, an optical reading type storage medium such as a CD, a CDV, an LD, or a DVD, or a magnetic storage type/optical reading type storage medium such as an MO. Any storage medium is included in the exemplary embodiments as long as the storage medium is computer-readable regardless of a reading method such as electronic, magnetic, or optical.

In addition, in the first and the second exemplary embodiments, the layout system, the layout apparatus, the layout program, the template selection program, the storage medium having stored therein the layout program, the storage medium having stored therein the template selection program, as well as the layout method in accordance with the exemplary embodiment are applied to the case in which the structured document 2 is automatically laid out in accordance with a layout template. However, the exemplary embodiments are not limited to this, and the layout system, the layout apparatus, the layout program, the template selection program, the storage medium having stored therein the layout program, the storage medium having stored therein the template selection program, as well as the layout method are applicable to other cases in a range not departing from the scope and spirit of the exemplary embodiments.

1. A layout system that lays out structured data in which plural layout elements are logically structured, comprising:
a template selecting device that selects a layout template defining a layout of plural information storage frames;
a template structure changing device that changes a logical structure of the layout template selected by the template selecting device on the basis of a logical structure of the structured data; and
a layout device that stores the layout elements, which are included in the structured data, in the information storage frames to perform layout in accordance with the layout template changed by the template structure changing device;
the template selecting device selecting a layout template which has the same number of information storage frames as the layout elements included in the structured data.

2. A layout system that lays out structured data in which plural layout elements are logically structured, comprising:
a template storing device that stores plural layout templates defining layouts in which plural information storage frames are arranged in a predetermined layout area;
a template selecting device that selects the layout template from the template storing device;
a template structure changing device that changes a logical structure of the layout template selected by the template selecting device on the basis of a logical structure of the structured data; and
a layout device that stores the layout elements, which are included in the structured data, in the information storage frames to perform layout in accordance with the layout template changed by the template structure changing device,
when it is judged that a layout template consistent with the logical structure of the structured data is not present in the template storing device, the template selecting device selects a layout template which has the same number of information storage frames as the layout elements included in the structured data.

3. The layout system according to claim 2,
at least one of attributes of the layout elements and attributes of information storage frames, in which the layout elements should be stored, being set for the layout elements,
at least one of attributes of layout elements, which should be stored in the information storage frames, and attributes of the information storage frames being set in the information storage frames, and
for each attribute of the layout elements included in the structured data, the template selecting device selects a layout template, which has the number of information storage frames of the attribute identical with the number of layout elements of the attribute included in the structured data.

4. The layout system according to claim 2,
when it is judged that the layout template, having the same number of information storage frames as the number of the layout elements included in the structured data, is not present in the template storing device, the template selecting device selects a layout template having the number of the information storage frames that are closest to the number of the layout elements included in the structured data.

5. The layout system according to claim 4,
the template structure changing device adding or deleting an information storage frame to or from a layout, defined by the layout template selected by the template selecting device, such as the number of the layout elements included in the structured data and the number of the information storage frames being identical with each other, and then a logical structure of the layout template changes.

6. The layout system according to claim 2, further comprising:
an information storage frame adjusting device that adjusts arrangement positions and sizes of the information storage frames in the layout, being defined by the layout template changed by the template structure changing device, on the basis of predetermined adjustment rules.

7. The layout system according to claim 6,
the predetermined adjustment rules being defined on the basis of design knowledge.

8. A layout apparatus that lays out structured data, including plural layout elements being logically structured, the layout apparatus comprising:
a template selecting device that selects a layout template defining a layout of plural information storage frames;
a template structure changing device that changes a logical structure of the layout template selected by the template selecting device on the basis of a logical structure of the structured data; and
a layout device that stores the layout elements, being included in the structured data, in the information storage frames to perform layout in accordance with the layout template changed by the template structure changing device,
the template selecting device selecting a layout template having the same number of information storage frames as the number of the layout elements included in the structured data.

9. A layout apparatus that lays out structured data, including plural layout elements being logically structured, the layout apparatus comprising:
a template storing device that stores plural layout templates defining layouts in which plural information storage frames are arranged in a predetermined layout area;
a template selecting device that selects the layout template from the template storing device;
a template structure changing device that changes a logical structure of the layout template selected by the template selecting device on the basis of a logical structure of the structured data; and
a layout device that stores the layout elements, which are included in the structured data, in the information storage frames to perform layout in accordance with the layout template changed by the template structure changing device,
when it is judged that a layout template consistent with the logical structure of the structured data is not present in the template storing device, the template selecting device selects a layout template which has the same number of information storage frames as the number of the layout elements included in the structured data.

10. The layout apparatus according to claim 9,
at least one of attributes of the layout elements and attributes of information storage frames, in which the layout elements should be stored, being set for the layout elements,
at least one of attributes of layout elements, which should be stored in the information storage frames, and attributes of the information storage frames being set in the information storage frames, and
for each attribute of the layout elements included in the structured data, the template selecting device selects a layout template, which has the same number of information storage frames of the attribute as the number of layout elements of the attribute included in the structured data.

11. The layout apparatus according to claim 9,
when it is judged that a layout template, which has the same number of information storage frames as the number of the layout elements included in the structured data, is not present in the template storing device, the template selecting device selects a layout template which has the closest number of the information storage frames as the number of the layout elements included in the structured data.

12. The layout apparatus according to claim 11,
the template structure changing device adds or deletes an information storage frame to or from a layout, being defined by the layout template selected by the template selecting device, such that the number of the layout elements included in the structured data is the same as the number of the information storage frames and, then, a logical structure of the layout template changes.

13. The layout apparatus according to claim 9, further comprising:
an information storage frame adjusting device that adjusts arrangement positions and sizes of the information storage frames in the layout, being defined by the layout template changed by the template structure changing device, on the basis of predetermined adjustment rules.

14. The layout apparatus according to claim 13,
the predetermined adjustment rules are defined on the basis of design knowledge.

15. A layout program for laying out structured data in which plural layout elements are logically structured, including a program to cause a computer to execute processing, the layout program comprising:
selecting a layout template defining a layout of plural information storage frames;
changing a logical structure of the layout template selected on the basis of a logical structure of the structured data; and
storing the layout elements, which are included in the structured data, in the information storage frames to perform layout in accordance with the changed layout template,
in selecting the layout template, a layout template having the same number of information storage frames as the number of the layout elements included in the structured data is selected.

16. A layout program for laying out structured data in which plural layout elements are logically structured, including a program to cause a computer, capable of using a template storing device that stores plural layout templates defining a layout in which plural information storage frames are arranged in a predetermined layout area, to execute processing comprising:
selecting the layout template from the template storing device;
changing a logical structure of the layout template selected on the basis of a logical structure of the structured data; and
storing the layout elements, included in the structured data, in the information storage frames to perform layout with the changed layout template,
in selecting the layout template, when it is judged that a layout template consistent with the logical structure of the structured data is not present in the template storing device, a layout template, which has the same number of information storage frames as the number of the layout elements included in the structured data, is selected.

17. A template selection program to select a layout template that is used for laying out structured data in which plural layout elements are logically structured, including a program to cause a computer to execute processing comprising:
selecting a layout template defining a layout of plural information storage frames; and
changing a logical structure of the layout template selected on the basis of a logical structure of the structured data,
in selecting the layout template, a layout template, which has the same number of information storage frames as the number of the layout elements included in the structured data, is selected.

18. A template selection program for selecting a layout template that is used for laying out structured data in which plural layout elements are logically structured, including a program to cause a computer, which is capable of using a template storing device that stores plural layout templates defining a layout in which plural information storage frames are arranged in a predetermined layout area, to execute processing comprising:
selecting the layout template from the template storing device; and
changing a logical structure of the layout template selected in the template selected on the basis of a logical structure of the structured data,
in selecting the layout template, when it is judged that a layout template consistent with the logical structure of the structured data is not present in the template storing device, a layout template, which has the same number of information storage frames as the number of the layout elements included in the structured data, is selected.

19. A computer readable storage medium having stored therein a layout program for laying out structured data in which plural layout elements are logically structured, storing a program to cause a computer to execute processing, the program comprising:
a program for selecting a layout template defining a layout of plural information storage frames;
a program for changing a logical structure of the layout template selected on the basis of a logical structure of the structured data; and
a program for storing the layout elements, which are included in the structured data, in the information storage frames to perform layout in accordance with the changed layout template,
in the program for selecting a layout template, a layout template, which has the same number of information storage frames as the number of the layout elements included in the structured data, is selected.

20. A computer readable storage medium having stored therein a layout program to lay out structured data in which plural layout elements are logically structured, storing a program to cause a computer, capable of using a template storing device that stores plural layout templates defining a layout in which plural information storage frames are arranged in a predetermined layout area, to execute processing, the program comprising:
a program for selecting the layout template from the template storing device;
a program for changing a logical structure of the layout template selected in the template selecting step on the basis of a logical structure of the structured data; and
a program for storing the layout elements, which are included in the structured data, in the information storage frames to perform layout in accordance with the changed layout template,
in the program for selecting the layout template, when it is judged that a layout template consistent with the logical structure of the structured data is not present in the template storing device, a layout template, which has the same number of information storage frames as the number of the layout elements included in the structured data, is selected.

21. A computer readable storage medium having stored therein a template selection program to select a layout template that is used to lay out structured data in which plural layout elements are logically structured, storing a program to cause a computer to execute processing, the program comprising:
a program for selecting a layout template defining a layout of plural information storage frames; and
a program for changing a logical structure of the layout template selected on the basis of a logical structure of the structured data,
in the program for selecting the layout temple, a layout template, which has the same number of information storage frames as the number of the layout elements included in the structured data, is selected.

22. A computer readable storage medium having stored therein a template selection program to select a layout template that is used to lay out structured data in which plural layout elements are logically structured, storing a program to cause a computer, which is capable of using a template storing device that stores plural layout templates defining a layout in which plural information storage frames are arranged in a predetermined layout area, to execute processing, the program comprising:
a program for selecting the layout template from the template storing device; and
changing a logical structure of the layout template selected on the basis of a logical structure of the structured data,
in the program for selecting the layout template, when it is judged that a layout template consistent with the logical structure of the structured data is not present in the template storing device, a layout template, which has the same number of information storage frames as the number of the layout elements included in the structured data, is selected.

23. A layout method of laying out structured data in which plural layout elements are logically structured, comprising:
selecting a layout template defining a layout of plural information storage frames;
changing a logical structure of the layout template selected on the basis of a logical structure of the structured data; and
storing the layout elements, which are included in the structured data, in the information storage frames to perform layout in accordance with the changed layout template,
in selecting the layout template, a layout template, which has the same number of information storage frames as the layout elements included in the structured data, is selected.

24. A layout method of laying out structured data in which plural layout elements are logically structured, comprising:
selecting a layout template defining a layout, in which plural information storage frames are arranged in a predetermined layout area, from a template storing device having stored therein a plurality of the layout templates;
changing a logical structure of the layout template selected on the basis of a logical structure of the structured data; and
storing the layout elements, which are included in the structured data, in the information storage frames to perform layout in accordance with the changed layout template,
in selecting a layout template, when it is judged that a layout template consistent with the logical structure of the structured data is not present in the template storing device, a layout template, which has the same number of information storage frames as the number of the layout elements included in the structured data, is selected.

25. A layout method of laying out structured data in which plural layout elements are logically structured, comprising:
selecting, with an arithmetic unit, a layout template defining a layout of plural information storage frames;
changing, with the arithmetic unit, a logical structure of the layout template selected on the basis of a logical structure of the structured data,
storing, with the arithmetic unit, the layout elements, which are included in the structured data, in the information storage frames to perform layout in accordance with the changed layout template,
in selecting, with an arithmetic unit, a layout template, which has the same number of information storage frames as the number of the layout elements included in the structured data, is selected.

26. A layout method of laying out structured data in which plural layout elements are logically structured, comprising:
selecting, with an arithmetic unit, a layout template defining a layout, in which plural information storage frames are arranged in a predetermined layout area, from a template storing device having stored therein a plurality of the layout templates;
changing, with the arithmetic unit, a logical structure of the layout template selected on the basis of a logical structure of the structured data; and
storing, with the arithmetic unit, the layout elements, which are included in the structured data, in the information storage frames to perform layout in accordance with the changed layout template,
in selecting, with an arithmetic unit, a layout template, when it is judged that a layout template consistent with the logical structure of the structured data is not present in the template storing device, a layout template, which has the same number of information storage frames as the number of the layout elements included in the structured data, is selected.
